(19) United States
(12) Patent Application Publication
(10) Pub. No.: US 2026/0159222 A1
(43) Pub. Date: Jun. 11, 2026

(54) Foldable Propeller Hub Mechanisms Based on Rolling Elements

(71) Applicant: EMRAER SA, Sao Jose dos Compos - SP (BR)

(72) Inventors: Henrique Böckmann Alves, Sao Jose dos Campos- SP (BR); Douglas de Moura Germano, Sao Jose dos Compos - SP (BR); Azélio Pasquini, Sao Jose dos Compos - SP (BR); Márcio Koiti Matuo, Sao Jose dos Compos - SP (BR); Cynthia Ponciano Marques, Sao Jose dos Compos - SP (BR); André Luiz de Paula Possobom, Sao Jose dos Compos - SP (BR); Tomás Wayhs Tech, Sao Jose dos Compos - SP (BR); Ricardo Akira Nagaya, Sao Jose dos Compos - SP (BR)

(21) Appl. No.: 19/356,451

(22) Filed: Oct. 13, 2025

Related U.S. Application Data
(60) Provisional application No. 63/707,135, filed on Oct. 14, 2024.

(51) Int. Cl. B64C 11/04; B64C 11/46

(52) U.S. Cl. CPC B64C 11/04; B64C 11/46

(57) ABSTRACT

An inner hub rotates inside an outer hub. Blades are mounted over these hubs. A plunger is installed inside the inner hub and has axial movement. Inner hub, outer hub and plunger have their axial and rotational movements linked so the mechanism has only a single degree of freedom limited by mechanical stops in respective stow and deploy positions. This link is made using spheres that roll inside grooves, so no sliding occurs during deployment for load path interfaces. This reduces friction and, therefore, wear and hysteresis.

### CROSS-REFERENCE TO RELATED APPLICATIONS

The present application claims benefit of U.S. Provisional Patent Application No. 63/707,135 filed Oct. 14, 2024, which is incorporated herein by reference in its entirety and for all purposes.

### FIELD

Technology herein relates to aircraft propulsors that can fold/reconfigure when not in use. More particularly, the technology relates to mechanisms that allows the blades of a multi-blade propeller to align automatically when deactivated to reduce drag and/or volume. This can be used for any propeller based vehicle where a folding feature is beneficial.

### BACKGROUND

### Technical Problem to be Solved

While many aircraft propellors have a single blade, multiblade propellers can absorb the torque of higher power engines or motors and provide higher thrust without increasing the size (diameter) of the propeller (which may be limited by ground clearance or structural clearance, depending on the propeller's orientation). Challenges to using a multi-blade propeller design include high oscillatory loads during transition phases when using a dual blade design and/or high drag during the cruise phase when using a multiblade design.

Those familiar with row boating may know how to feather their oars to reduce wind resistance when rowing into a breeze. Such feathering entails turning the oars 90 degrees when the blades come up out of the water so the blades present the smallest possible surface profile to the oncoming wind. The oars are rotated again when entering the water again to maximize the blades' displacement of water in the next stroke.

Similar general principles can be used for marine and aircraft propellors.

For example, folding propellors are known for use on sailboats, motor-gliders, self-launching sail planes, ultralight aircraft, and drones. In such designs, when the motor begins rotating, centrifugal force swings the blades outward into operating position for propulsion. When the motor or other moving source stops rotating, airflow folds the blades back away from the motor and its drive shaft into stow positions, to minimize drag. This folding reduces drag, allowing the vessel to glide efficiently through water or air without resistance by stationary fixed propeller blades.

In aeronautics, a feathering propeller is a constant-speed propeller used on multi-engine aircraft that has a mechanism to change the pitch to an angle of approximately 90°. A propeller is usually feathered when the engine fails to develop power to turn the propeller. By rotating the propeller blade angle parallel to the line of flight, the drag on the aircraft is greatly reduced. With the blades parallel to the airstream, the propeller stops turning and minimum windmilling, if any, occurs. The blades are held in feather by aerodynamic forces. See AMT Handbook—Powerplant, Chapter 7 “Propellers” (FAA-H-8083-32B), www.faa.gov/sites/faa.gov/files/09_amtp_ch7.pdf, incorporated herein by reference.

Teetering (or tethering) involves articulation between a dual-blade propeller and motor shaft that allows the blade to flap and feather, reducing the bending moment to the shaft. This reduces oscillatory loads, but not as much as a multi-blade design.

Other prior work proposes foldable hub solutions for this mechanism, however each of them have at least one of the following limitations:
Sliding joints: friction leads to wear and hysteresis
Torsion spring inside the hub: use of a torsion spring may be a limitation due to the volume available inside the hub. A compression or even a traction spring based cartridge has the tendency to be smaller.
Mechanism with more than 1 degree of freedom (DOF): a mechanism with more than 1 DOF is harder to achieve the position and to actuate properly.
Lack of provision to increase mechanism breakout: depending on the aircraft and propeller design, it may be necessary to provide an initial torque to deploy (breakout) higher than the full deployment torque to assure that the mechanism won't open in cruise phase.
Change in the distance between blades: each blade, when spinning, creates its own field of velocities around itself and is designed according to that. Therefore, aerodynamically, the lower the axial distance between the blades, the better, because, otherwise, the airfoil will work out of the design point. Some prior designs need axial movement of part of the blades for their kinematics.
Mechanism volume: some of the proposed mechanisms have the tendency to be bulky. Concepts that use an actuator, more than one motor or a gearbox to spin part of the propeller blades independently of the other part have this characteristic. Also, mechanisms based on bell cranks and rods may result in a large volume even with low loads due to minimum hardware size (bearings, bolts, nuts, minimum wall thickness, etc.)
Dedicated actuation system: an actuator or a motor dedicated to phase/align the blades of the same propeller adds weight, cost and complexity to the system.

### BRIEF DESCRIPTION OF THE DRAWINGS

FIGS. 1A-1C are together a flip chart animation showing a propeller hub mechanism that deploys two propellers from a folded position to a deployed position in response to rotational torque.

FIG. 2 shows an example of a propeller hub mechanism with 2 sets of dual-blades with a plunger fixed to a motor.

FIGS. 2A-2D are together a flip chart animation that animates the FIG. 2 view of the outer hub in response to rotational torque from the motor.

FIGS. 3A-3D are together a flip chart animation that animates the inner hub operation in response to rotational torque from the motor.

FIGS. 4A-4D are together a flip chart animation that animates the plunger operation in response to rotational torque from the motor.

FIG. 5 shows an example spring cartridge within the FIG. 2 hub.

FIG. 5A shows an example of non-linear mechanism behavior.

FIG. 6 shows a sequence of images depicting a centrifugal lock concept.

FIG. 6A shows an example mechanism with 2 sets of dual-blades, comprehending a quadri-blade when deployed: Left—stowed; Right—deployed.

FIG. 7 shows an example grooves and cage mechanism for variable leverage along the mechanism stroke.

FIG. 7A shows an example hub phasing lock. From left to right: outer hub, sleeve, phasing lock disengaged, phasing lock engaged.

FIG. 8 shows a cross-section of an example embodiment of a mechanism with 2 sets of dual-blades with outer hub fixed to motor.

FIG. 8A shows a further cross-sectional view of the FIG. 1 foldable hub mechanism in a deployed position.

FIG. 8B shows a cross-section of the FIG. 1 foldable hub in a stowed position.

FIG. 9 shows a further embodiment of a propeller hub with a lift-actuated foldable mechanism and a solenoid actuator.

FIG. 10 shows the FIG. 9 embodiment with the lower hub locked to a motor shaft.

FIG. 11 shows the FIG. 9 embodiment with the lower hub locked to the motor housing.

FIGS. 12-27 are together a flip chart animation showing dynamical operation of the FIG. 9 embodiment. To play the animation, please size the drawings in your browser or other viewer and use the “page down” key to advance the animation from FIG. 12 to FIG. 13, from FIG. 13 to FIG. 14, and so on.

FIG. 28 shows an example motor driver program control flow.

FIG. 28A shows an example motor controller/driver including sensors and a non-transitory memory storing the motor driver program.

FIG. 29 shows an example VTOL aircraft that can benefit from use of the arrangements described herein.

### DETAILED DESCRIPTION OF NON-LIMITING EMBODIMENTS

A propeller hub to angularly displace a first propeller relative to a second propeller from a first angular position to a second angular position different from the first angular position, the propeller hub being connectable to a rotatable shaft, the propeller hub comprising at least one spherical connector that is selectively moveable within at least one corresponding groove or channel to selectively lock at least one of the first propeller and the second propeller in a predetermined angular position relative to the other propeller.

The spherical connector comprises a sphere.

The propeller hub includes a spring that acts on a displaceable plunger or sleeve within the hub.

The propeller hub further includes an actuator that selectively acts against force the spring applies.

The propeller hub further includes a centrifugal lock.

The propeller hub further comprises a plurality of sets of grooves or channels that are angularly arranged about the shaft.

The at least one corresponding groove or channel is defined within the shaft.

The first relative angular position comprises a stowed position and the second relative angular position comprises a deployed position.

The first and second propellers are parallel to one another in the first relative angular position and are anti-parallel to one another in the second relative angular position.

The propeller hub is configured to angularly displace the first propeller relative to the second propeller in a first direction based on drag torque, and to displace the first propeller relative to the second propeller in a second direction relative to the first direction in response to inertial torque and spring bias.

The propeller hub further comprises a sleeve configured to move axially to the motor shaft between a first sleeve position and a second sleeve position, the sleeve being further configured to lock engagement of the first propeller to the shaft in the first sleeve position, the sleeve being further configured to lock engagement of the first propeller to a housing of the motor in the second sleeve position.

A propeller hub connectable to a rotatable motor shaft, the propeller hub comprising: a slidable structure that is slidable between a first position and a second position; a spring that urges the slidable structure toward the first position; and at least one sphere that is selectively moveable within at least one corresponding groove or channel to selectively lock a propeller in a predetermined angular position relative to the shaft depending on the slidable position of the slidable structure.

The propeller hub further includes an actuator that urges the slidable structure toward the second position.

The propeller hub has no actuator that urges the slidable structure toward the second position.

The propeller hub further includes a further propeller fixedly connected to the shaft.

The slidable structure comprises a plunger.

The slidable structure comprises a sleeve.

The propeller hub further includes a centrifugal locking device.

The at least one sphere includes plural spheres angularly spaced about the shaft that are selectively, synchronously moveable within corresponding grooves or channels also angularly spaced about the shaft, wherein the angular positions of the grooves or channels are changeable relative to the plural spheres.

An aircraft comprising a wing, a motor applying torque to a shaft; a first propeller connected to the shaft; and a propeller hub connected to the shaft, the propeller hub transmitting torque from the shaft to a second propeller, wherein the propeller hub is configured to change the angular position of the second propeller relative to the shaft, wherein the propeller hub includes at least one spherical connector that selectively moves into or through a corresponding channel or groove to selectively lock the second propeller in a predetermined changed angular position to generate thrust for the aircraft.

### Non-Actuator Based Hub

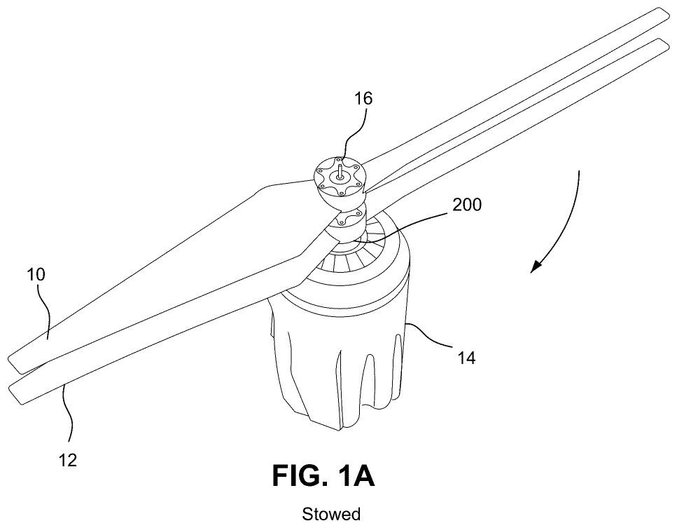

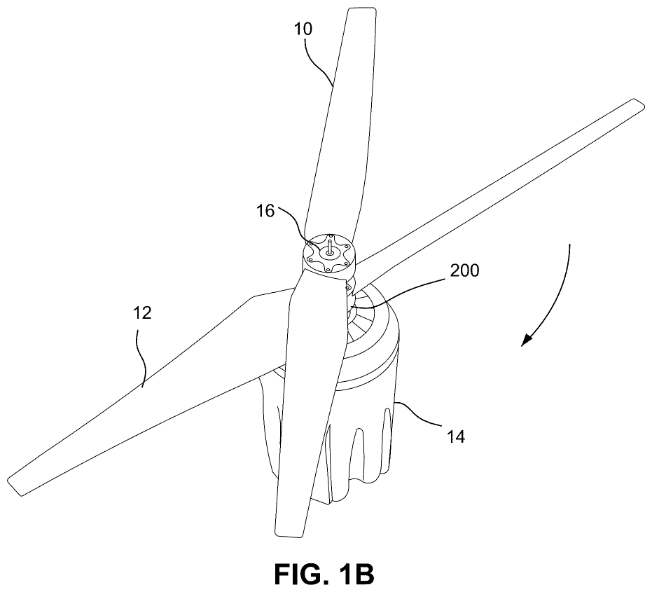

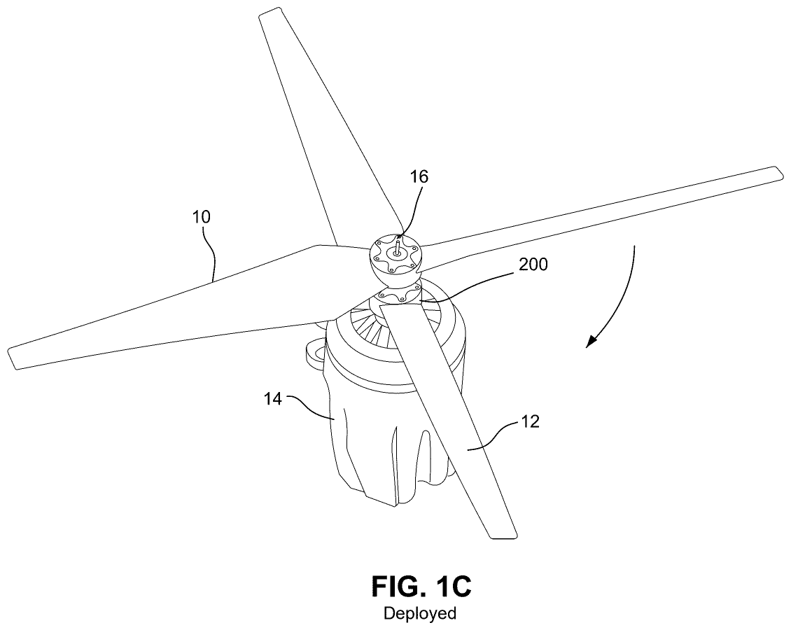

FIGS. 1A-8B show a first example folding propeller hub 200 that uses and requires no actuator to operate.

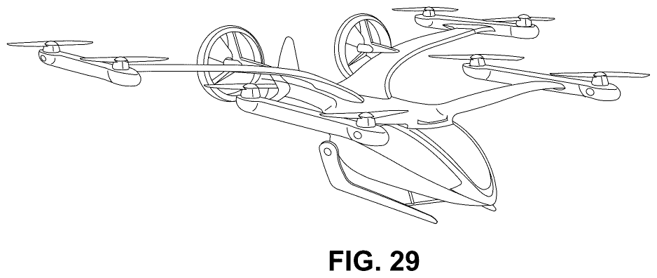

The FIG. 1A-1C together shows a flip chart animation of deployment of propellers 10, 12 using such a hub 200. A motor 14 applies rotational torque to a motor shaft 14 for rotating propellers 10, 12 (in this case in a clockwise direction) to generate thrust such as lifting thrust for navigating an aircraft such as shown in FIG. 29. FIG. 1A shows the propellers 10, 12 starting in a folded or stowed position, with their blades parallel to one another. To deploy the propellers 10, 12, motor 14 simply applies rotational torque to the motor shaft. When sufficient rotational torque is applied, hub 200 automatically deploys the propellers 10, 12 by advancing one blade relative to the other (see FIGS. 1B, 1C) until the two propellers are perpendicular to one another and form a cross or X. In the example embodiment, one of the propellers (e.g., the lower propeller 12) is fixed to the motor shaft 16 and thus rotates with the motor 14 at all times. The second propeller (e.g., the upper propeller 10 in this particular embodiment) meanwhile changes its angular position relative to the shaft 16 and the first propeller due to drag torque acting on the second propeller. Hub 200 limits the angular displacement of the second propeller relative to the first propeller (e.g., 90 degrees in one embodiment) to achieve a desired relative angular displacement suitable for flight operations.

Once the two propellers 10, 12 achieve a deployed configuration as shown in FIG. 1C, they maintain this relative orientation as long as the motor 14 continues to apply sufficient rotational torque, i.e., rotational torque above a lower threshold needed to maintain the deploy configuration. When the motor 14 ceases to produce sufficient rotational torque, operation of an internal spring retards one propeller relative to the other propeller (this can be seen by viewing the FIG. 1A-1C flip chart animation in reverse, starting from FIG. 1C, then to FIG. 1B, then to FIG. 1A) to return propellers 10, 12 to their stowed positions shown in FIG. 1A. In particular, the lower propeller 12 continues to rotate with the motor shaft 16 whereas the upper propeller 10 gradually retards its rotation relative to the motor shaft 16 and the lower propeller until the two propellers are again parallel. The propellers 10, 12 can thus gradually be angularly displaced relative to one another between a stowed position where the two propellers are parallel to one another, and a deployed position where the two propellers are anti-parallel to one another.

In brief summary, in an example embodiment the lower propeller 12 remains at a fixed angular position relative to the shaft 16, whereas hub 200 can change the variable (within a range) angular position of the upper propeller 10 relative to the shaft and the lower propeller. In the example embodiment, this range is 90 degrees, so that the upper propeller 10's angular position relative to the shaft 16 can vary between (a) a first angular position where the upper propeller is exactly aligned with the lower propeller and the upper and lower propellers have the same angular positions relative to the shaft, and (b) a second angular position where the upper propeller is not aligned with the lower propeller and the upper and lower propellers have different angular positions relative to the shaft. In example embodiments, non-alignment of the upper and lower propellers' angular positions is such that the two propellers are orthogonal to one another, and alignment of the upper and lower propeller's angular positions are the same relative to the motor shaft 16.

In an example embodiment, no actuator other than motor 14 is used or required to accomplish the switchover from stowed configuration to deployed configuration or the switchover from deployed configuration to stowed configuration as shown in FIGS. 1A-1C and described above. Rather, as described below, shaft torque (inertia) and drag torque, as well as the bias of an internal spring accomplishes this switchover. Meanwhile, spherical connectors travelling through various grooves hold/lock the two propellers 10, 12 in either the stowed configuration (FIG. 1A) or the deployed configuration (FIG. 1C) as appropriate until torque conditions motor 14 applies to the motor shaft 16 warrants a switchover to a different configuration.

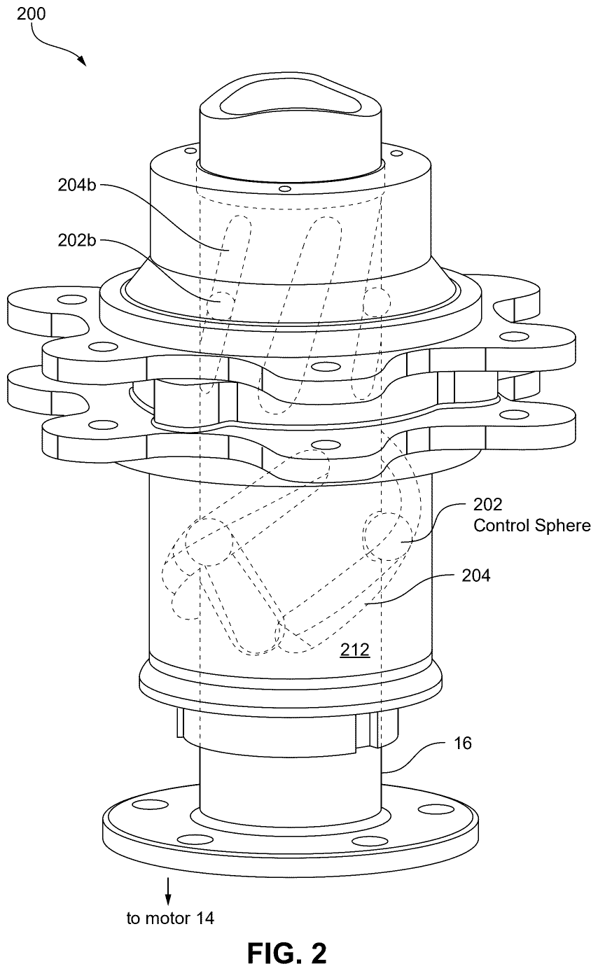

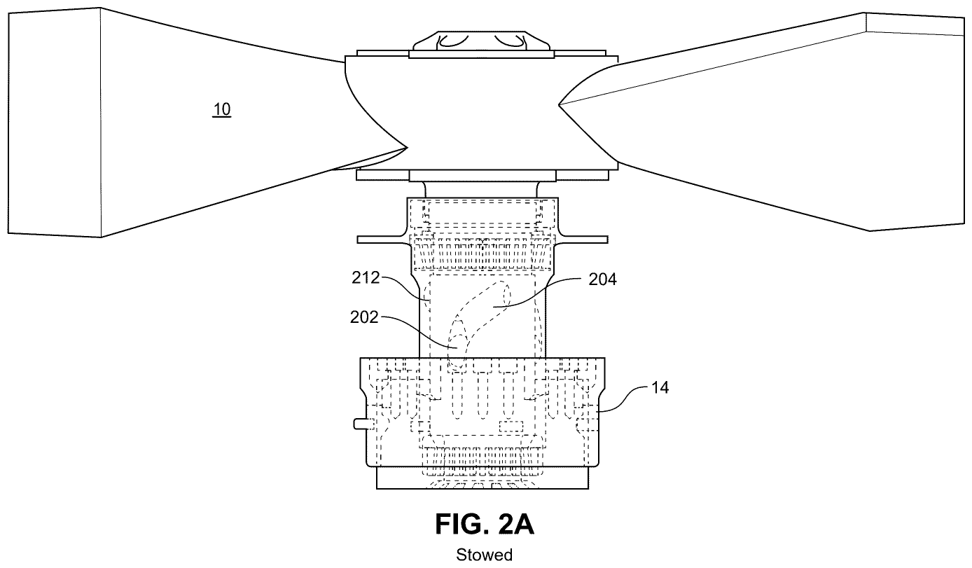

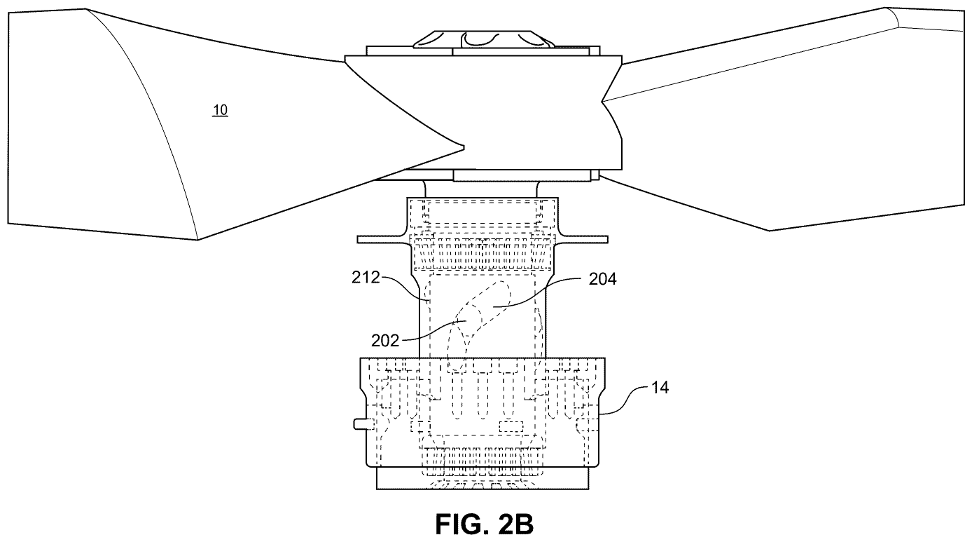

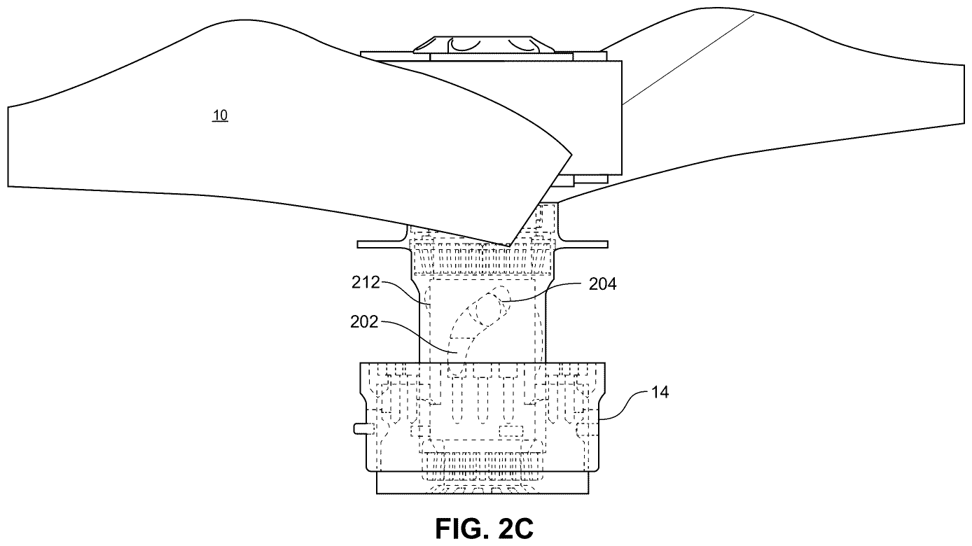

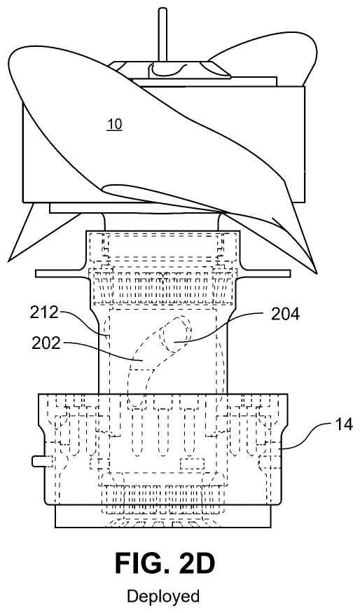

FIG. 2 shows an example hub 200 structured and operated to accomplish the above result. In the example shown, hub 200 is connected (e.g., bolted) to motor 14 to extend motor drive shaft 16 which passes upward (in the view shown) through the hub to the propellers 10, 12. Torque the motor 16 applies to the drive shaft 16 causes the hub 200 to rotate the propellers 10, 12 as described above. When the motor 14 applies less than a certain amount of torque to the shaft 16, the hub 200 automatically “folds” the two propellers 10, 12 together in a stow position so the two propellors are parallel to one another and can present a smaller profile to oncoming wind (the motor can be controlled to precisely position the common angular orientation of the two propellers relative to wind direction to minimize drag). When the motor 16 applies more than a certain amount of torque to the shaft 16, the hub 200 automatically reconfigures the propeller arrangement in a deployed configuration in which the upper and lower propellers 10, 12 form an X or cross (one propeller's axial direction is perpendicular to the other propeller's axial direction) and spins the two propellers together to develop thrust e.g., to provide lift or forward thrust for an aircraft such as shown in FIG. 29. No active electrical, hydraulic or other actuator is needed to control or operate the hub 200 to switch between the stowed state and the deployed state—the hub works based on motor torque applied to shaft 16, drag torque acting on the upper propeller 10, and bias of an internal spring). Since no actuator is required, actuator failure is not a reliability issue for this design.

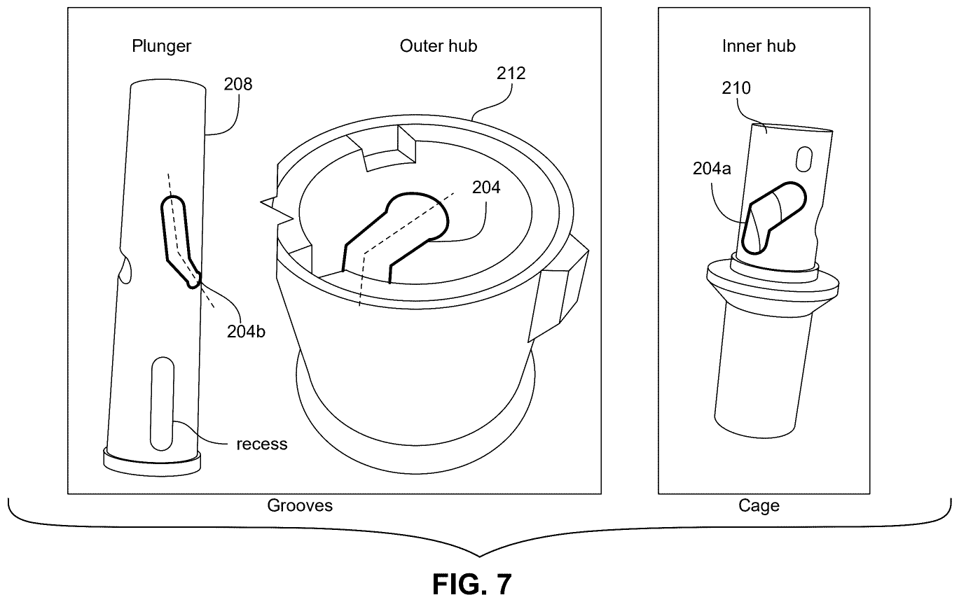

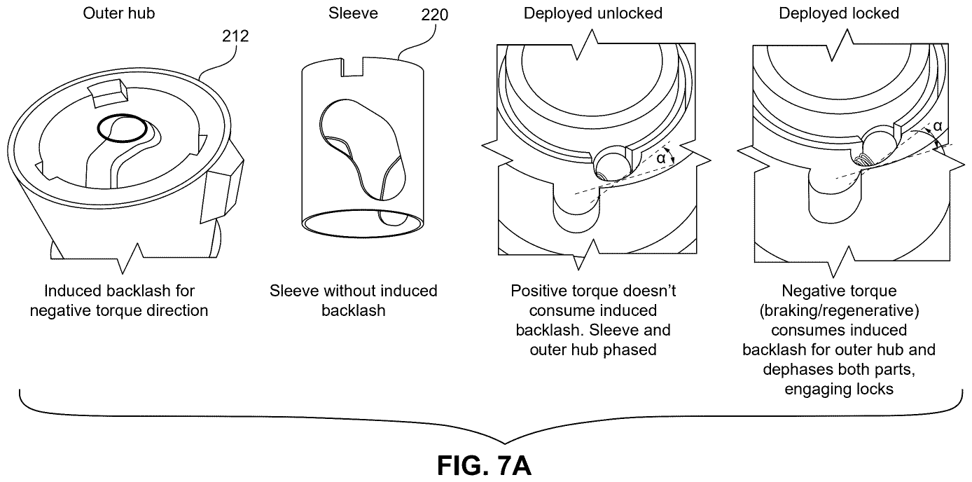

The example proposed hub mechanism shown in FIG. 2 comprises an inner hub 210 that rotates inside an outer hub 212. Propellor blades 10, 12 are mounted over these hubs 210, 212. A plunger 208 is disposed within the inner hub 210 and has axial movement. See FIG. 7 for example elevated views of the inner hub 210, outer hub 212 and plunger 208. Inner hub 210, outer hub 212 and plunger 208 have their axial and rotational movements linked so the hub 200 mechanism has only 1 DOF limited by mechanical stops in respective stow and deploy positions. This link is made using spheres 202 that roll inside grooves 204, so no sliding occurs during deployment for load path interfaces. This reduces friction and, therefore, wear and hysteresis. See FIGS. 2, 6A, 8, 8A, 8B.

In more detail, the example embodiment operates by selectively linking the outer hub 212 to the inner hub 210, and the inner hub 210 to the plunger 208, using respective spheres that travel through respective arcuate linking grooves based on centrifugal force as the entire assembly rotates. The outer hub 212 is connected to the engine shaft 16, and the inner hub is connected to the upper propeller 10. A plunger 208 meanwhile displaces upwards based on applied torque, and displaces downwards based on force a spring 206 applies. When the outer hub 212, inner hub 212 and plunger 208 are all linked together by respective spheres in corresponding channels or grooves, they all rotate together and the lower propeller 12 and upper propeller 10 rotate together. Because the various respective grooves 204, 204a, 204b that spheres 202, 202b travel through are arcuate and travel around the circumferences of the outer hub 212, inner hub 212 and plunger 208, the amount of circumferential travel of spheres 202, 202b determines an angular offset of upper propeller 10 relative to lower propeller 12 before the outer hub 212, inner hub 212 and plunger 208 become linked. This offset in one example embodiment is 90 degrees. When the outer hub 212, inner hub 212 and plunger 208 are all linked, the two propellers 10, 12 rotate together with shaft 16 but the two propellers retain their now-set angular offset relative to one another—that is, the respective grooves 204, 204a, 204b and spheres 202, 202b lock the relative angular positions of the two propellers.

FIGS. 2A-2D are together a flip chart animation showing how a spherical connector or ball 202 moves within a groove 204 defined in the outer hub 212 as the shaft 16 turns the propellers 10, 12. It can be seen that the sphere 202 gradually travels from one end of an arcuate groove 204 to another end of the arcuate groove as the shaft 16 rotates.

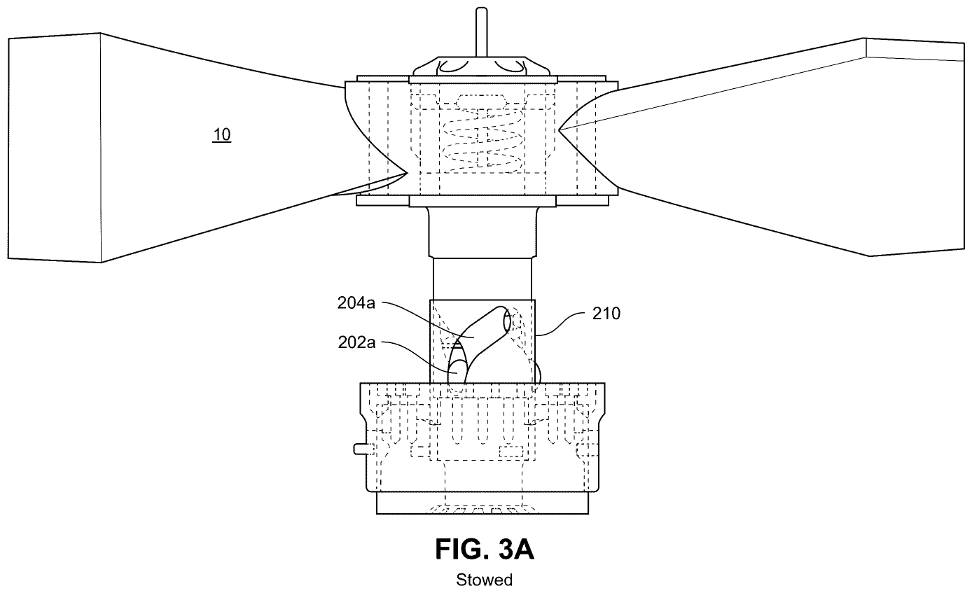

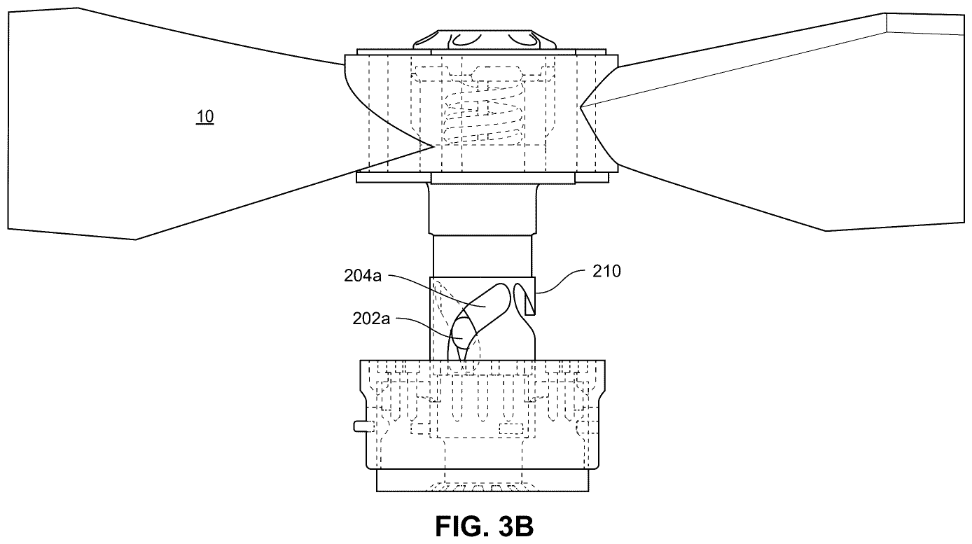

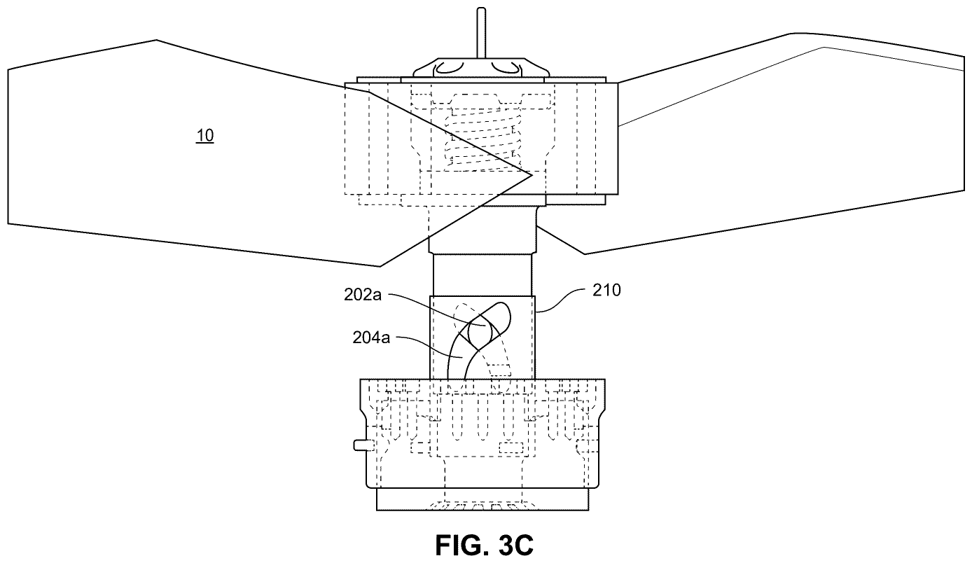

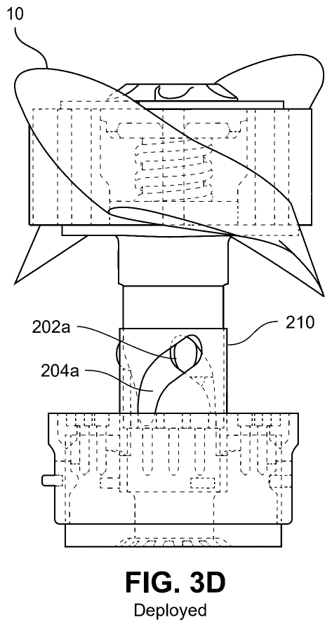

This arcuate groove 204 in outer hub 212 communicates with a further groove 204a defined in inner hub 210 (see FIG. 7). FIGS. 3A-3D show a further flip chart animation which animates how the sphere 202 also travels through the arcuate groove 204a defined within the inner hub 210, as the shaft 16 turns.

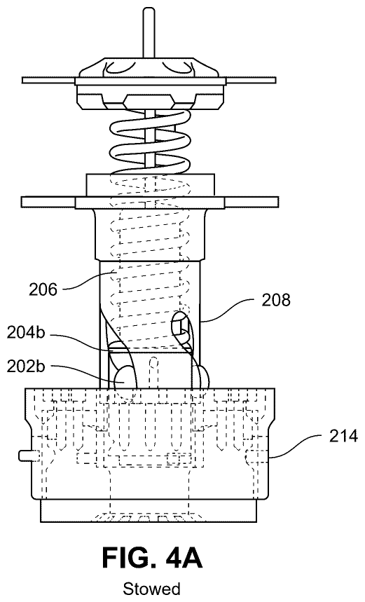

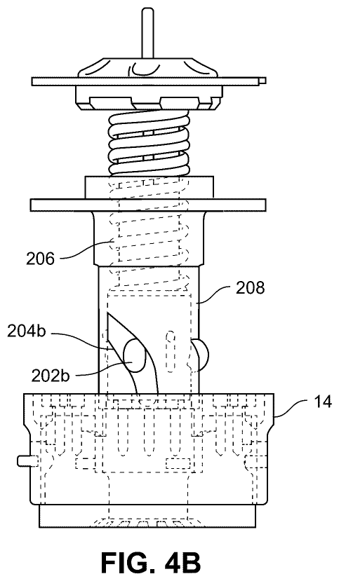

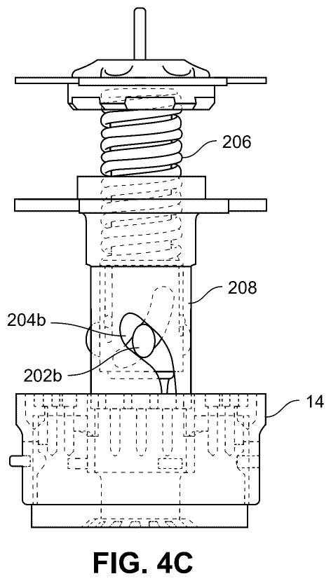

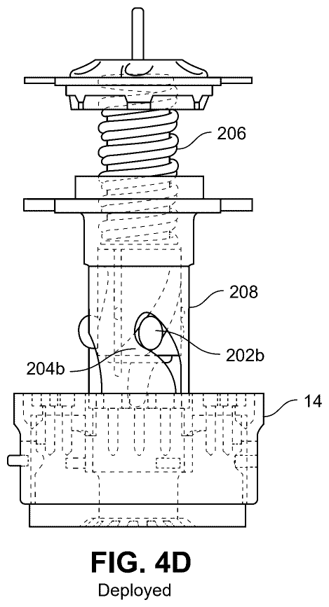

FIGS. 4A-4D show yet another flip chart animation which animates how another sphere 202b travels through a third arcuate groove 204b defined in plunger 208 as the shaft 16 turns. FIGS. 4A-4D also indicate that there can be plural or multiple sets of grooves 204, 204a, 204b and associated spheres 202, 202a, 202b angularly spaced around the structures shown, to provide additional strength and balanced support. Such multiple sets operate independently at the same time and synchronously.

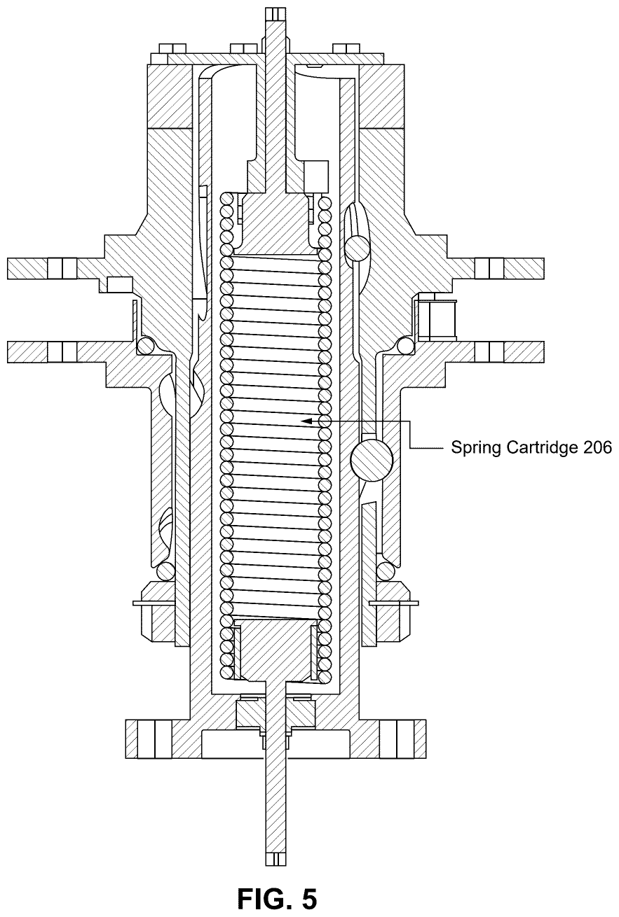

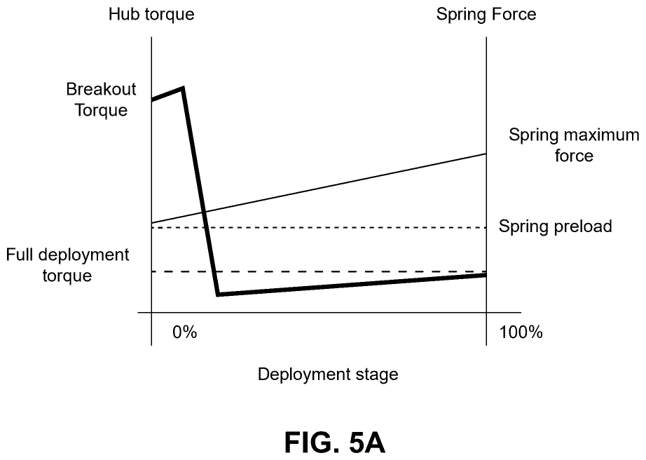

As these flip chart animations show, when the shaft 16 and propeller 10 starts to spin, drag torque and/or inertia are responsible to resist the blades movement, deploying the mechanism and tensioning an internal spring 206 based seen in the FIG. 5 cross-section. In particular, FIG. 5 shows an arrangement of the same concept where the spring is extended during deploy. When drag or inertia torque acts over upper and lower hub, both can rotate in relation to the plunger. Due to the grooves path where the upper and lower sets of spheres roll, this rotation causes translation of the plunger as well. Translation of upper and lower hub is the same because they are linked with roller or sliding bearings, however, the rotation of these hubs during this stroke will differ the deploy angle. The translation stroke is the amount that the spring cartridge will be extended.

This spring cartridge may have a damper in parallel to control deploy, stow velocity and/or to allow the noback feature operation. Also, the preload of this spring cartridge relates to the torque the mechanism provides to keep the propellers stowed during cruise, withstanding windmilling torque. A linear spring cartridge 206, with or without damper, is assembled pulling or pushing the plunger 208. This cartridge 206 may have a preload and is further loaded when the mechanism goes from stowed position (FIG. 4A) to deployed position (FIG. 4D), so the mechanism has the tendency to go to stowed position. This spring cartridge 206 thus is used to return the hub 200 to the stowed configuration from the deployed configuration when the motor 14 ceases to apply sufficient torque to maintain the hub 200 in the deployed configuration and the spheres 202, 202b thus travel in reverse directions from plunger groove 204b to inner hub groove 204a, to outer hub groove 204, back to their starting positions. This travel can be observed by viewing the flip chart animations backwards from 4D-4A, 3D-3A, 2D-2A.

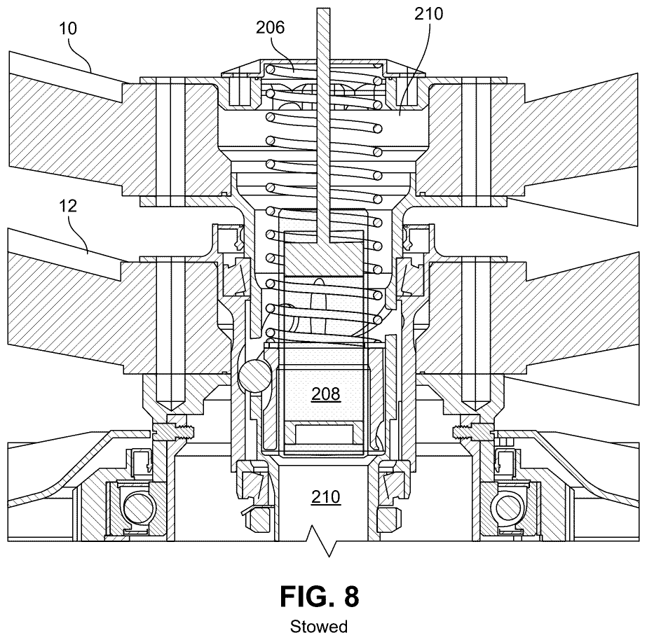

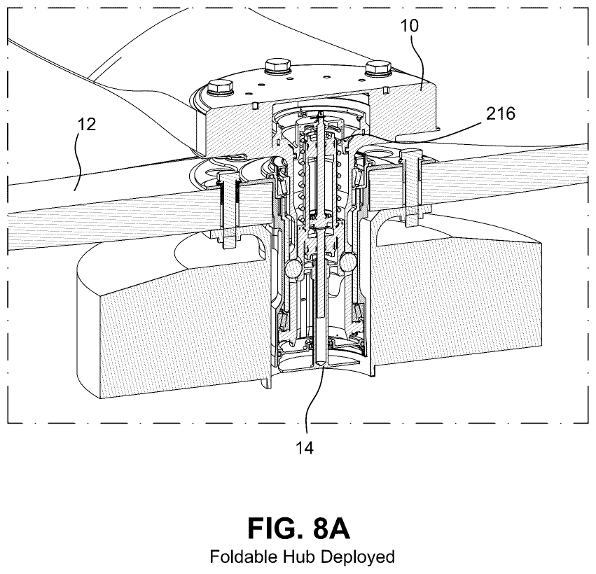

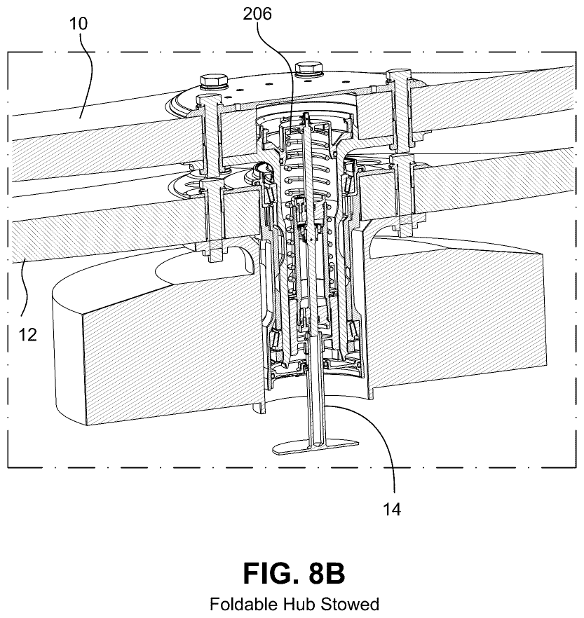

In the FIG. 8, 8A, 8B cross-sectional views, FIG. 8 shows a concept where the lower hub is rotated in such speed that the upper hub starts to shift out of phase relative to lower hub until it reaches 90 degrees of difference, due to inertia and drag torque on propellers attached to them. Meanwhile, inside the mechanism, the command spheres (larger ones), that are encapsulated between plunger, noback sleeve (interfaces lower hub) and upper hub, start rolling in the grooves present in these 3 parts, at the same time, turning the upper hub in relation to lower hub and rising the plunger inside the upper hub. Due to damper and spring compression, plunger movement is controlled. Smaller spheres assist on longitudinal (vertical) parts movement and larger spheres actuate during rotational movement.

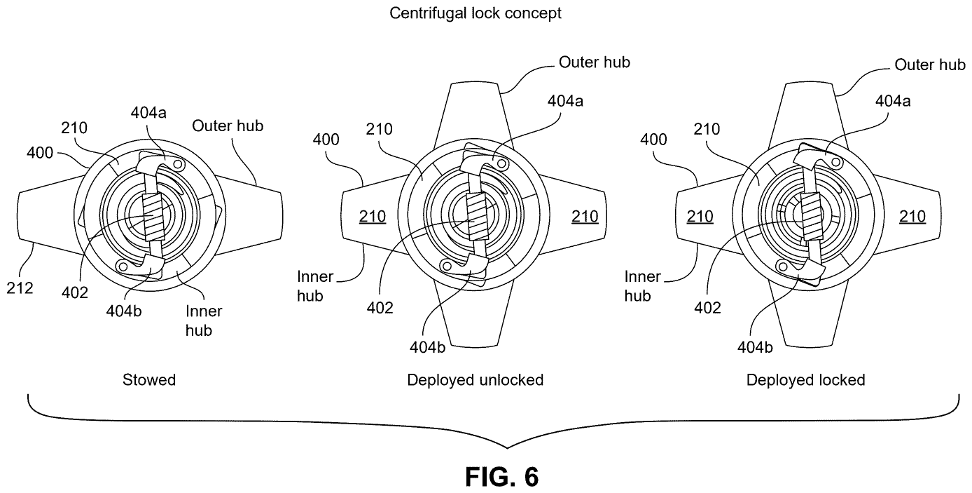

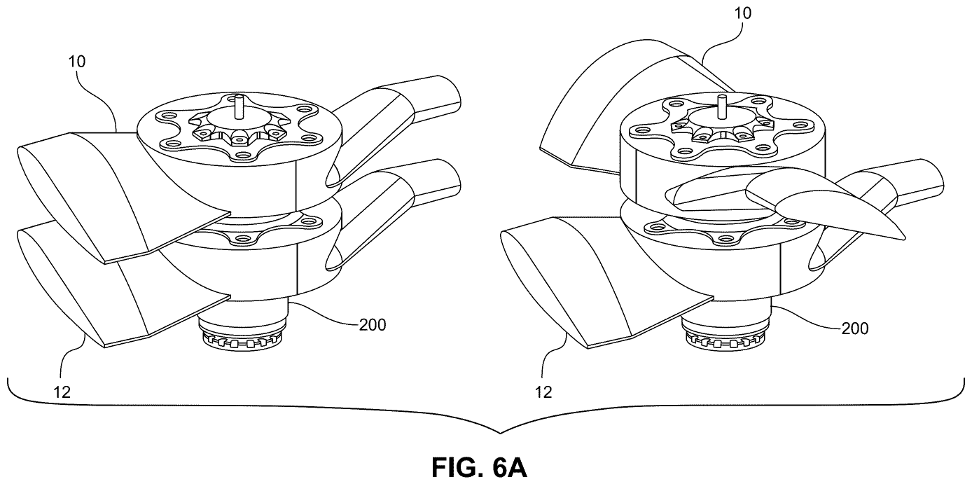

The grooves 204, 204a, 204b may have different angles along their path to provide different leverages between plunger translation and hubs rotation along the deployment stroke (see FIG. 6A). This enables a specific mechanism behavior (resisting torque VS deployment stage) to be obtained, for instance increasing the breakout while decreasing the torque to full deployment (see example in FIG. 5A). To avoid unwanted sphere 202 sliding along such grooves that could result in additional mechanism DOFs or even jamming, the inner hub 210 has a recess that acts as cage (see FIG. 7) for the set of spheres 202 linking the plunger to the outer hub 212.

FIG. 6 shows an example centrifugal lock 400 that engages inner hub to outer hub. When deployed, such a mechanism can be locked in the deployed state with such a centrifugal lock that opens beyond a specific rotational speed, which is above full deployment speed. An embodiment has locking devices that engage at least 2 mechanism parts (inner hub 210—outer hub 212; shaft 216—outer hub 212; shaft 216—inner hub 210), preventing unwanted returning due to a gust or regenerative/braking shaft torque. In this example, item 402 is a centrifugal lock spring, and items 404a, 404b are locking devices such as tabs or grippers. The lock 400 has three states as shown: stowed (lefthand view); deployed unlocked (center view); and deployed locked (righthand view).

This embodiment relies only on draft torque and inertia to open the mechanism. No actuator is needed or required. When the motor driving the shaft is turned off, the spring 206 closes the mechanism again.

For designs where minimum deployed speed requirement, which defines the speed in which de lock must engage, is too low or hub radius is too small, acceleration available for counterweights actuation may be not enough for a reliable operation. In this case, a locking feature based on torque direction and hub phasing is proposed. An induced backlash is added between plunger translational movement so if the hub torque is negative (braking/regenerative torque), this backlash is consumed. For normal operation, where the torque is positive, nothing happens. A sleeve is added inside the outer hub without the induced backlash.

In this arrangement, every time a regenerative/braking torque is applied to the hub, it consumes the backlash while the sleeve remains in the same position. This relative rotation between sleeve and hub engages locking devices (locking arms, spheres, rollers, etc.) locking the mechanism. See 7A for more details.

This hub phasing lock can use a positive engagement as shown in FIG. 7A, where a locking device engages inside a recess on the other part, or can use lower pressure angles and rely in wedging to lock the mechanism, with no recess needed on the counterpart. This way, lower lock backlashes can be achieved and the locking feature can work along all the mechanism stroke.

With the described mechanism, it is possible to use a multi-blade rotor during hover and transitional flight (lifters on and vehicle with translational velocity) with reduced oscillatory loads as well as align all blades to flight direction during cruise, when the lifters are off. Also, the proposed mechanism relies on rolling elements for its kinematics, so reduced wear and friction is expected. The capability to tune the ratio of plunger translation and hub rotation along the stow-deploy stroke offers the possibility to balance the mechanism's behavior so the mechanism won't present unwanted deployments during cruise even for designs where a low minimum operational rotational speed is needed.

The proposed deployed locking features also avoid an unwanted blade stowing if a regenerative/braking torque occurs.

### Lifter Actuated Foldable Mechanism

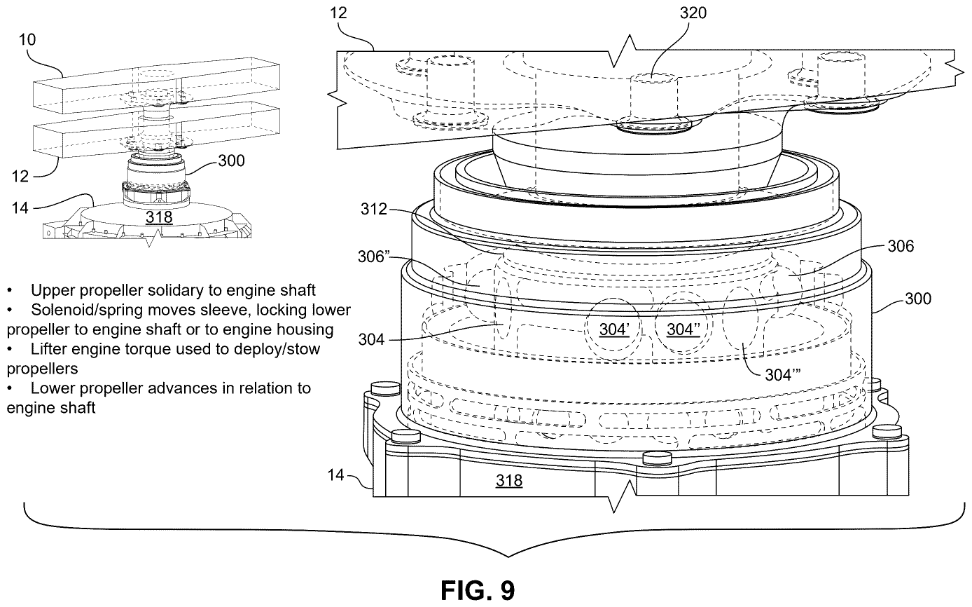

FIGS. 9-27 show a further propeller hub embodiment that is lifter actuated. In this embodiment, the hub rigidly and continuously couples the upper propeller 10 directly to the motor shaft 314 without any intermediate decoupling mechanism. No folding or deploy-stow mechanism acts on the upper propeller 10—it is always and continuously directly connected to the motor shaft 314. This direct coupling/connection ensures that whenever the motor shaft 314 rotates, the upper propeller 10 will rotate also. The foldable mechanism in the hub thus has no effect or impact on the operation or configuration of the upper propeller 10, and operation or non-operation (e.g., failure) of the foldable mechanism will have no impact on thrust the upper propeller is able to produce.

In this FIG. 9 embodiment, a motor 14 provides rotational energy to rotate two propeller blades 10, 12. A hub 300 is disposed between the motor 14 and the propellers 10, 12. The hub 300 may be cylindrical in shape and include an outer housing including a lower outer portion that is bolted or otherwise fastened to the housing of motor 14 (or in one example could be integrated with the motor housing). A rotatable shaft 320 of motor 314 penetrates through hub 300 to the upper propeller 10 which is attached to this rotatable shaft. The upper propeller 10 thus rotates with shaft 320 whenever motor 14 drives the shaft.

The lower propeller 12 meanwhile is mounted to an internal lower hub structure that selectively connects the lower propeller to either (a) the motor 14 housing 318 or (b) the motor shaft 320. In this way, the lower propeller 12 is either (a) anchored to the motor housing 14 and thus remains stationary with respect to it, or (b) rotates with the motor shaft 320 and thus also with the upper propeller 10.

In particular, a cooperating solenoid/spring moves a sleeve 312 internal to the hub 300 up and down. In one sleeve 312 position, the lower propeller 12 is connected to rotate with the motor shaft 320. In another sleeve 312 position, the lower propeller 12 is anchored to the motor housing 318. Lifter motor torque is used to deploy/stow the propellers 10, 12 by selectively locking the lower propeller 12 to the motor shaft 320 or to the motor housing 318. In this embodiment, the lower propeller 12 advances in relation to the motor shaft 320.

In an example embodiment, the slidable sleeve 312 itself is not the structure that actually engages the lower propeller 12 to the motor shaft 320. Rather, relocation (sliding) of the sleeve 312 by a combination of the solenoid 314 and the spring 316 enables different sets of spherical connectors 306, 308 to connect the lower propeller 12 to either the motor shaft 320 or to the motor housing 318. In particular, upper spherical connectors 306 slide into associated grooves 304 in the motor shaft 320 to connect the lower propeller 12 to the motor shaft 320; or alternatively, different lower spherical connectors 308 slide into (different) associated grooves 310 in structure anchored to the motor housing 318 to anchor the lower propeller 12 to the motor housing 318.

As explained below, a combination of (i) rotational position of the motor shaft 320, (ii) the energization/deenergization of an electrically activated solenoid 314, and (iii) action of a spring 316, enables switchover between engaging the lower propeller 12 to the motor shaft 320 or engaging the lower propeller 12 to the motor housing 318. In particular, in example embodiments the motor 14 rotates the lower propeller 12 is the opposite direction of its intended rotational direction (as defined by the shape of its leading edge) to a switchover position in order to accomplish such a switchover. This switchover position enables the spherical connectors to respectively engage with or disengage from corresponding grooves in the motor shaft 320 or structure anchored to the motor housing 318. The solenoid 314 and spring 316 meanwhile each operate on the sleeve 312, lifting it up or down (in the orientation of the views shown). Change in position of the sleeve 312 causes the spherical connectors 306, 308 to engage with or disengage from shaft grooves 304 and housing grooves 310, respectively.

The preloaded spring 316 pushes sleeve 312 upward, and an electrically actuated solenoid 314 counteracts the bias of the spring to compress the spring and push the sleeve downward, in order to select which of the two sets of spherical connectors 306, 308 engage with shaft grooves 310 in the motor shaft 320 or housing grooves 310 anchored to the motor housing 318, respectively. This arrangement using a spring 316 to push sleeve 312 in a first direction and a solenoid 314 to push the sleeve against the spring in a second direction opposite the first direction has the advantage of minimizing the functionality of the solenoid, thereby increasing its robustness and reliability. In particular, because spring 316 rather than any actuator deploys propellers 10, 12 (by engaging the lower propeller 12 with the rotatable shaft 320), no actuator failure can result in a catastrophic failure preventing the aircraft from deploying propellers 10, 12 need for the aircraft staying aloft. In contrast, if the solenoid 314 were to fail, the resulting failure to stow propellers 10, 12 would increase drag but would not catastrophically prevent the aircraft from staying aloft. No actuator is relied on to deploy the propellers 10, 12 (the actuator is used only to return the propellors to their stowed position), nor is torque needed or relied on to change the relative angular positions of the two propellers in this design.

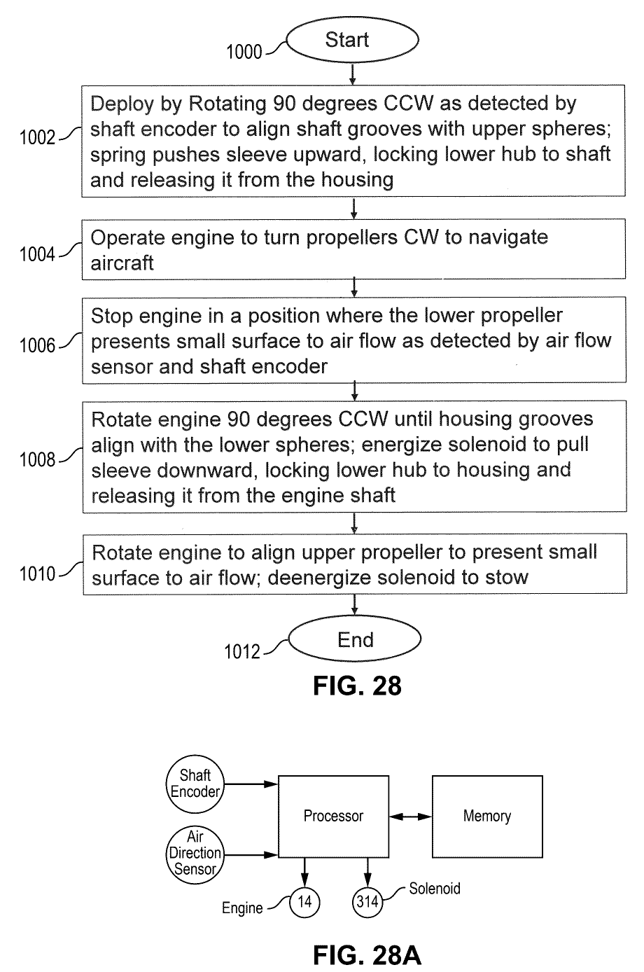

An electronic controller (see FIG. 28A) executing program control instructions stored in a non-transitory memory may control the motor 14 and the energization/de-energization state of solenoid 314 in order to control both (a) the precise rotational position of motor shaft 320, and (b) the position of the up-and-down slidable sleeve, in order to control deployment and stowage of the propellers 10, 12. The electronic controller can also measure wind direction and use that measurement to stow propellers 10, 12 in positions that will present smaller surfaces to the wind/air flow and thereby reduce or minimize drag. The controller may include all of these functions in motor driver software used to drive motor 14.

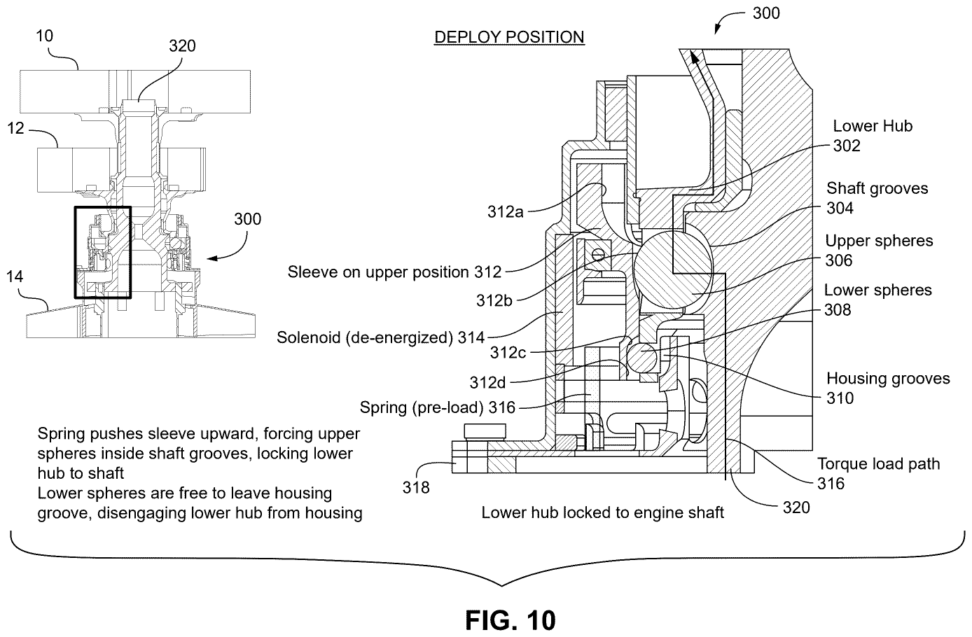

FIG. 10 shows two views of hub 300. In the left-hand view, shown in partial cross-section, the hub 300 can be seen disposed intermediately between the motor 14 and propellers 10, 12, with the motor shaft 320 penetrating through the hub to permanently connect the shaft to the upper propeller 10. The hub 300 thus does not decouple the motor shaft 314 from the upper propeller 10 in this embodiment—it selectively couples or decouples only the lower propeller 12 to/from the motor shaft.

The right-hand side of FIG. 10 shows a cross-section of lower hub structure within one portion of hub 300 as indicated within the black box within the left-hand view. In other words, the right-hand view is a magnified rendering of the portion of hub 300 delineated in the black box of the left-hand view. In example embodiments, hub 300 includes a plurality of sets of the spherical engagement structures shown in the right-hand view and also seen in FIG. 9. These plurality of sets of spherical engagement structures are disposed about different radial positions of hub 300 relative to the central shaft 320 (see FIG. 9). One embodiment may have two sets of such structures disposed on opposite sides of shaft 320, as indicated in the left-hand side view cross-section. Other hub 300 embodiments may have three, four, five, six, seven, etc. sets of such engagement structures disposed at different radial positions about shaft 320. For ease of explanation, the discussion below will describe the operation of a single set of such spherical engagement structures, but those skilled in the art will understand that plural/all sets of such structures included in hub 300 may be operated simultaneously and synchronously in the manner described to provide radially balanced, higher strength engagement/disengagement for lower propeller 12.

The FIG. 10 shows the hub mechanism 300 in the “deploy” position—meaning the lower propeller 12 is engaged with the shaft 320. In this deploy position, the preloaded spring 316 pushes the sleeve upwardly, forcing the upper spheres 306 inside corresponding aligned shaft grooves 304 defined in the motor shaft 320, and thereby engaging/locking the lower hub and lower propeller 12 to the motor shaft. The lower spheres 308 are free to leave corresponding housing grooves 310, disengaging the lower hub from the housing 318. In this deploy state, the sleeve 312 is in an upper position, the solenoid 314 is deenergized, and the spring 316 is preloaded. The torque load path 316 as shown as through the motor shaft 320, the upper spheres 306, to the lower propeller 12.

As can be seen, the slidable sleeve 312 in this deploy state has a retaining surface 312b that captures upper sphere 306 between it and the shaft 320, retaining the sphere within the shaft groove 304 and thus providing continual engagement of the hub with the shaft as the shaft rotates under the torque applied by motor 14. Meanwhile, the sleeve 312 defines a further surface 312d which in this deployed state and corresponding position of the sleeve releases the lower sphere 308 from engaging with the housing groove 310, thus disengaging the hub 300 from being anchored to the motor housing 318.

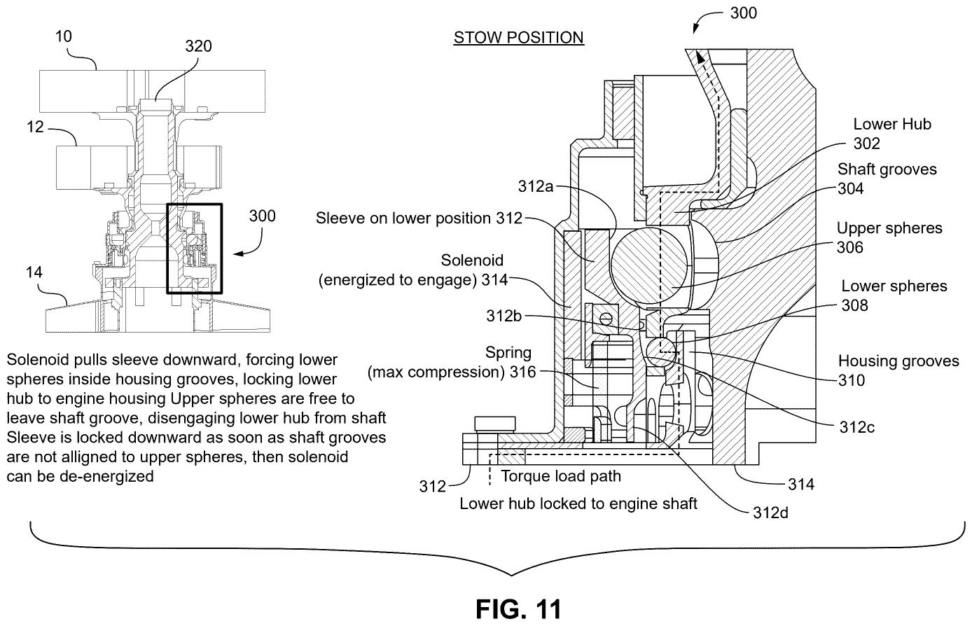

FIG. 11 shows the FIG. 9 mechanism in the “stow” state. In this stow state, the lower hub 300 is locked to the motor housing 312—not the motor shaft 320. To stow, the solenoid 314 is energized to pull the slidable sleeve 314 downward against the force of the spring 316 (which is at maximum compression under the solenoid's force), in turn forcing the lower spheres 308 inside corresponding housing grooves 310, which locks the lower hub to the motor housing. In particular, by sliding the sleeve 320 downward, the upper spheres 306 are freed to leave their shaft grooves 304 (they are no longer retained in the shaft grooves by sleeve retaining surface 312b), thereby disengaging the lower hub from the shaft 314. Meanwhile, sliding the sleeve 312 downward now brings sleeve surface 312c into contact with lower spheres 308 which presses the lower spheres into aligned corresponding housing grooves 310, thereby engaging the hub with structure anchored to the motor housing 312. The sleeve 312 is locked downward as soon as the shaft grooves 304 are not aligned with the upper spheres 306 based on turning the shaft 314 away from the position that aligns the upper spheres with corresponding shaft grooves 304. At that point, the solenoid 314 can then be de-energized without affecting the engagement/disengagement state of the mechanism (in other words, the hub remains disengaged from shaft 314 and anchored to motor housing 14 after the solenoid is deenergized). Thus, the solenoid 314 does not need to remain energized after the propellers 10, 12 are configured into the stow state; rather, the solenoid's energization is used only to configure the propellers 10, 12 into the stow position and may then be turned off (de-energized) to conserve power, reduce heating, and increase service life.

FIG. 11 shows the torque load path in stow state is changed relative to the torque load path in deploy state of FIG. 10. In the stow state of FIG. 11, the torque load path is from the motor housing 312 (which in this embodiment is stationary and does not move or turn) through the housing grooves 310/lower spheres 308 to the lower propeller 12. This stow state or configuration thus locks the lower hub to the motor housing 312 so the lower hub and the propellers attached thereto will not rotate such as in response to air currents or oncoming wind. As will be explained below, in this configuration the upper and lower propellers 10, 12 are aligned parallel to one another in positions relative to wind direction that reduce drag, with the upper propeller 10 being held in angular position by motor torque and the lower propeller 12 being held in position by the locking mechanism locking it to the motor housing 14.

In the example shown, the lower spheres 308 can be smaller in size than the upper spheres 306 because the anchoring force needed to anchor the lower propeller 12 to the motor housing 312 is substantially less than the connection force needed to transmit motor torque from shaft 314 to the lower propeller 12. Other embodiments can have different configurations.

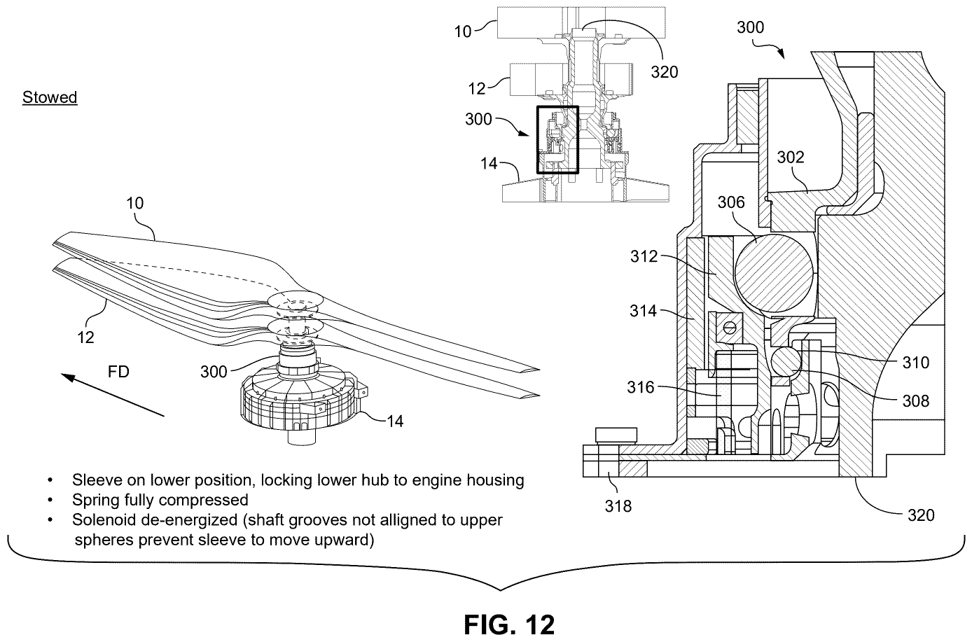

Each figure in the flip chart animation of FIGS. 12-27 includes three different views. The left-hand view shows the angular positions of upper propeller 10 and lower propeller 12 relative to hub 300 and motor 14. The right-hand view shows a magnified cross-sectional view of a portion hub 300 that is delineated by the black box of the upper view. The upper view is not intended to reflect the angular positions of propellers 10, 12 but is instead included merely as a reference.

Referring now to the flip chart animation of FIGS. 12-27, FIG. 12 shows the upper propeller 10 and lower propeller 12 aligned in the stow position. The sleeve is in the lower position, locking the lower hub to the motor housing. The spring 316 is fully compressed. The solenoid is de-energized and the shaft grooves 304 are not aligned to the upper spheres 306, such that the upper spheres block the sleeve from moving upward under the force of the spring 316.

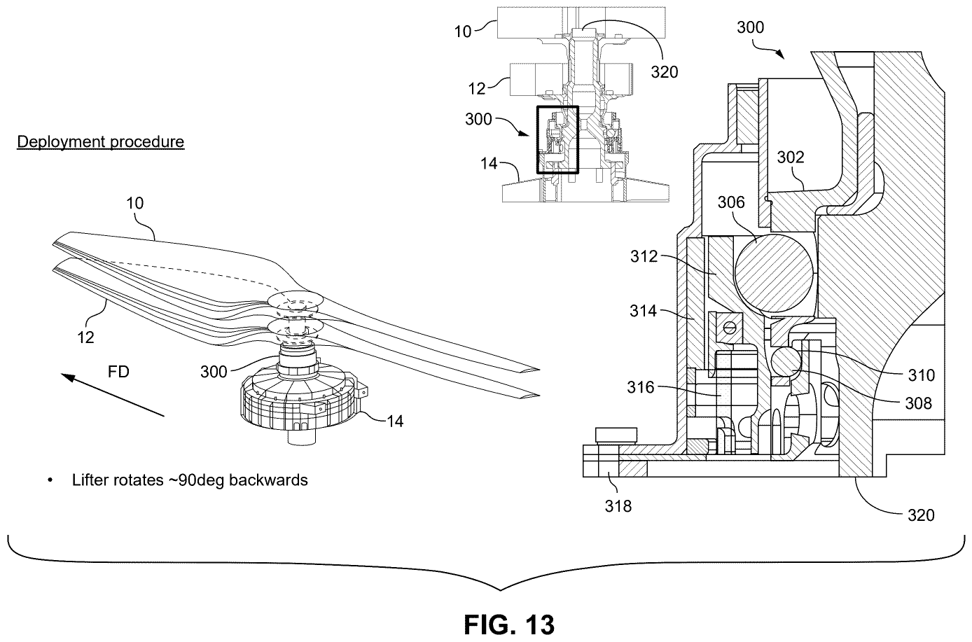

FIG. 13 (the second picture in the flip chart animation) shows the first step of a deployment procedure. Here, the lifter rotates a certain amount (e.g.,. about 90 degrees in one embodiment) backwards (counterclockwise) in FIG. 13, and as shown in FIGS. 14, 15 and 16, the lifter motor shaft rotates this certain amount (about 90 degrees in one embodiment) backwards (counterclockwise) (see also FIG. 28 block 1002). Since the upper propeller 10 is directly coupled to the lifter motor shaft, the upper propeller can be seen to rotate about 90 degrees counterclockwise. The purpose of the reverse shaft rotation is to align the upper spheres 306 with corresponding shaft grooves 304.

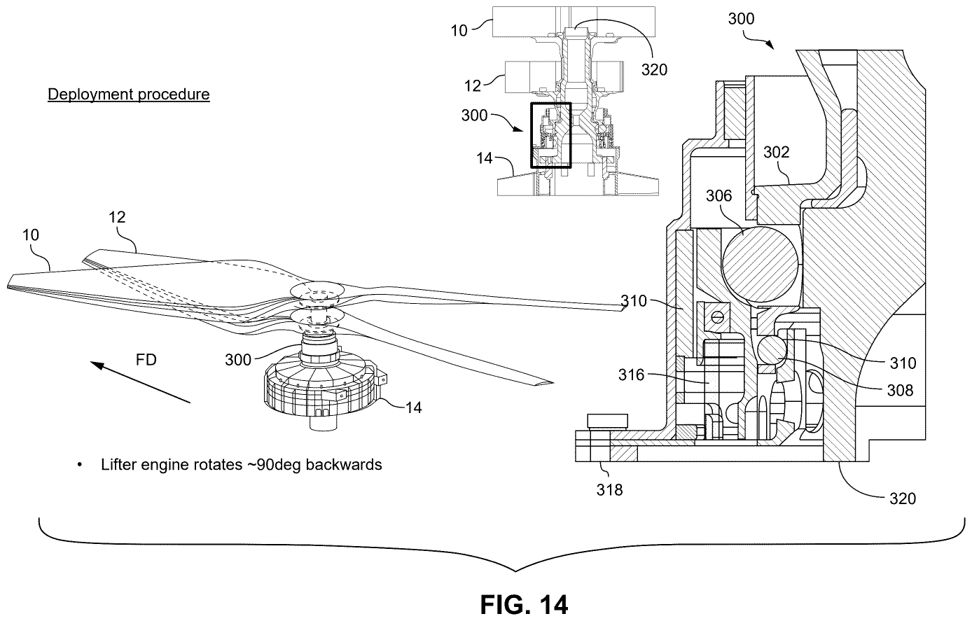

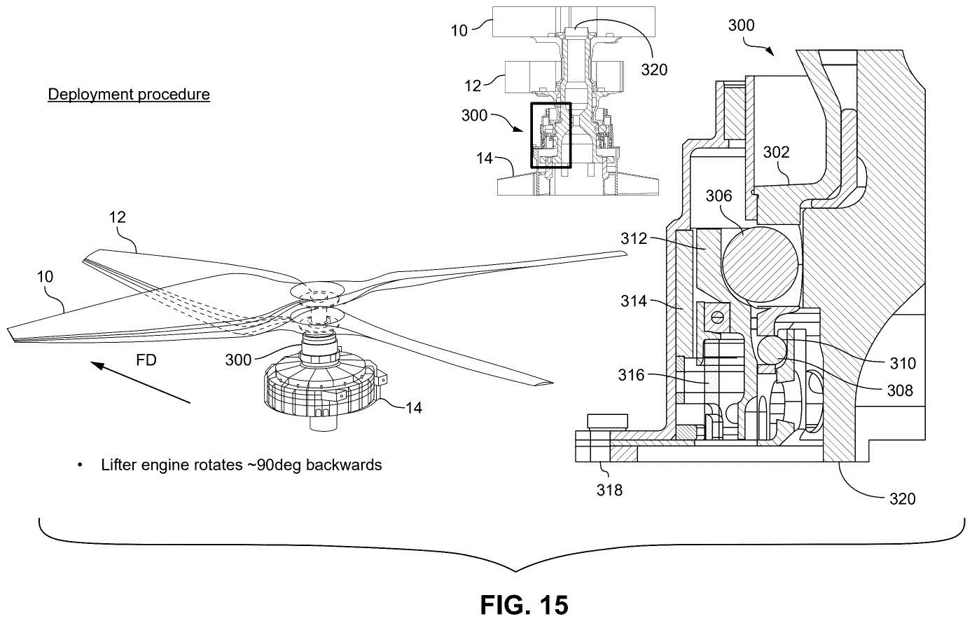

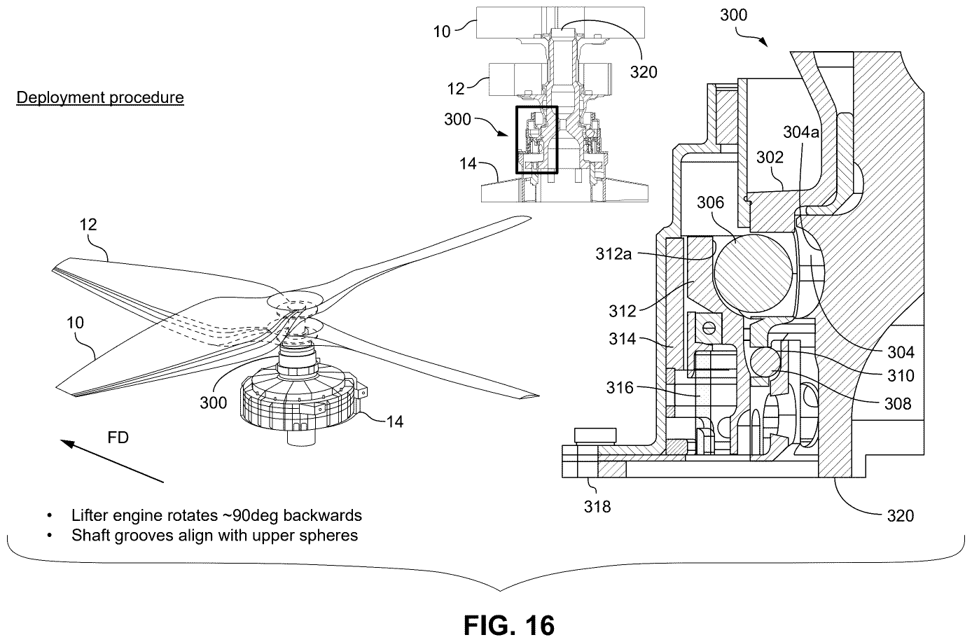

Once the lifter motor shaft reaches the about 90 degree counterclockwise position shown in FIG. 16, the shaft grooves 304 align with the upper spheres 306. In particular, shaft grooves 304 are located at predetermined radial angular intervals about shaft 320 (see FIG. 9) to align with corresponding spheres 306. Comparing FIG. 15 with FIG. 16, one can see that as the shaft 320 rotates counterclockwise, it brings its shaft groove 304 into alignment with sphere 306. The same occurs for all spheres 306 within the hub 300, i.e., shaft grooves 304 angularly spaced around the circumference of the shaft 320 align simultaneously with corresponding spheres 306, enabling each sphere 306 to begin rolling into its corresponding shaft groove 306.

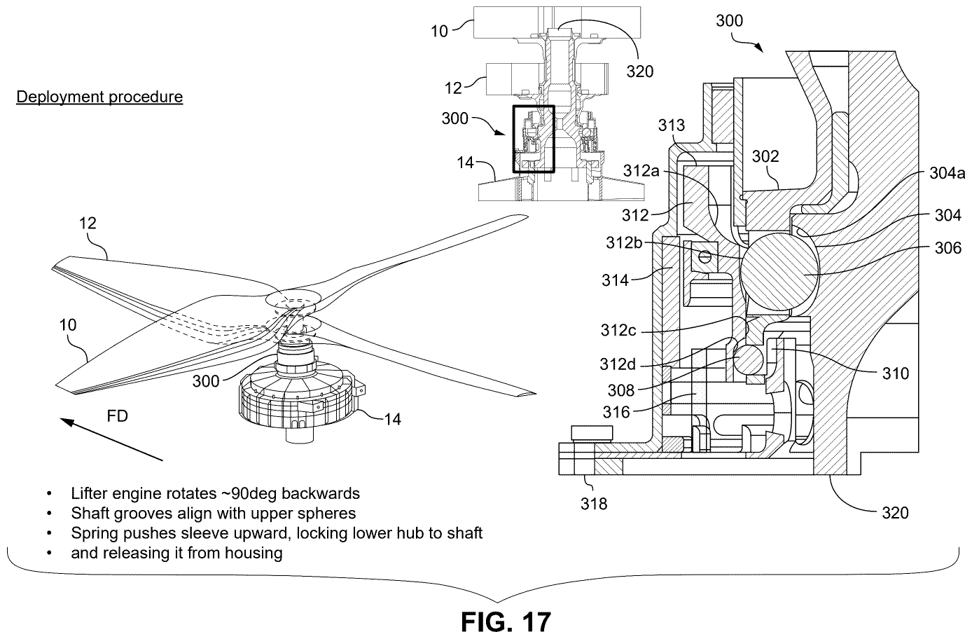

FIG. 17 shows that in this certain CCW position, the upper spheres 306 are able to move into their corresponding now-aligned shaft grooves 304, which change in position means the upper spheres no longer obstruct the lower hub sleeve 312 from moving upwardly from its lowermost position under the force of compressed spring 316. In particular, FIG. 16 shows that sleeve 312 has an inner surface 312a that is machined to have a curved profile matching the curvature of the sphere 306 but sized to accommodate the diameter of sphere 306. Since sleeve inner surface 312a is curved and the sphere 306 can roll, the sphere is able to roll towards and into the now-aligned shaft groove 304 whereas it was unable to do so before the shaft groove was aligned. With the sphere 306 no longer obstructing the sleeve 312 from moving upward under the force of spring 316, the spring pushes the sleeve upwards. As the sleeve 312 moves upwardly, the curved surface 312a in turn pushes the sphere 306 further into aligned shaft groove 304 until the sphere is pushed to the extreme righthand side (in this view) of groove 306.

The shaft groove 304 is machined to have a cuplike capturing surface 304 profiled to match the curved outer circumferential surface of sphere 306. At the position shown in FIG. 17, the sphere 306 has been pushed far into the groove 306 to contact the groove's capturing surface 304a, and the sphere no longer obstructs the sleeve 312 from moving further upward. The sleeve 312 therefore continues to move upward until it reaches a stop 313. Meanwhile, the sleeve 312 has been machined to also provide an additional, retaining surface 312b that provides only a small clearance with the sphere 306 when the sphere has been pushed all the way into the aligned groove 306 to contact the groove's capturing surface 304a. The sphere 306 is thus captured between the shaft groove capturing surface 304a and the sleeve retaining surface 312b, and is held firmly within the shaft groove 304 without undue vibration, as FIG. 17 shows.

The effect of sleeve 312 moving upward under the force of spring 316 is thus to lock the lower hub to the shaft 320 and releasing it from the housing. In particular, as FIG. 17 also shows, the lower portion of sleeve 312 has a lower sphere retaining surface 312c and a lower sphere releasing surface 312d. As the sleeve 312 moves upwards, the lower sphere retaining surface 312c moves upwardly to bring the lower sphere releasing surface 312d into contact with the lower sphere 308, permitting the lower sphere to roll out of the housing groove 310 and releasing the hub from the housing structure 318.

The lower hub thus now turns with the shaft 320 and is no longer anchored to the housing. Additionally, the upper spheres 306 moving into the now-aligned shaft grooves 304 retain the lower hub in the 90-degree counterclockwise position it moved to in FIGS. 14-17 so that the upper propeller 10 and lower propeller 12 remain unaligned with each other and are instead locked in a relative position that is 90 degrees apart-that is the upper propeller is orthogonal (anti-parallel) to the lower propeller and the two propellers form the shape of an X or cross in a head-on view. Note that the positional changes shown in FIGS. 13-17 did not require activation or operation of any actuator, but instead relied solely on operating the motor 14 to drive its shaft 320 counterclockwise.

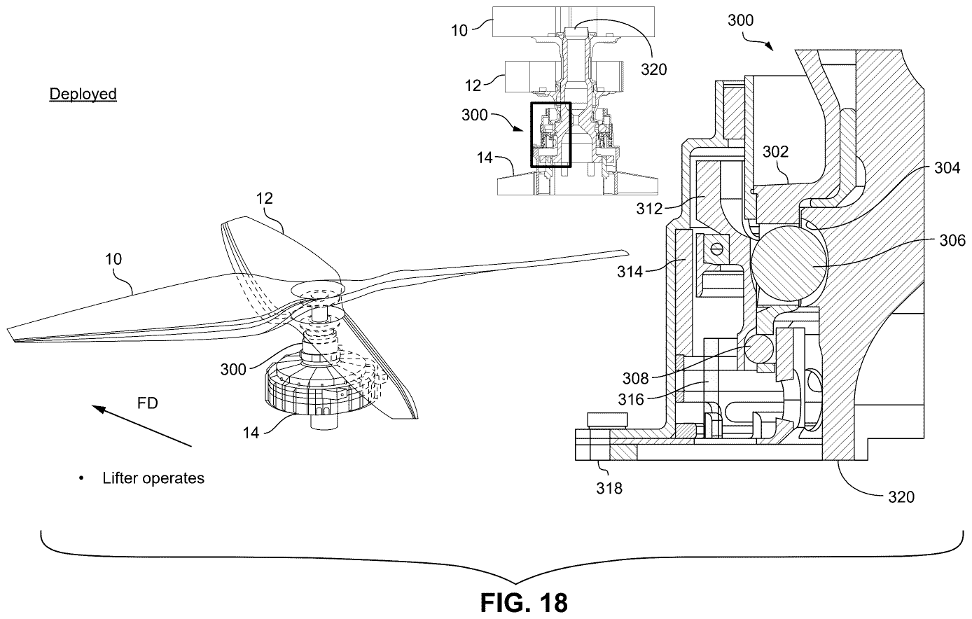

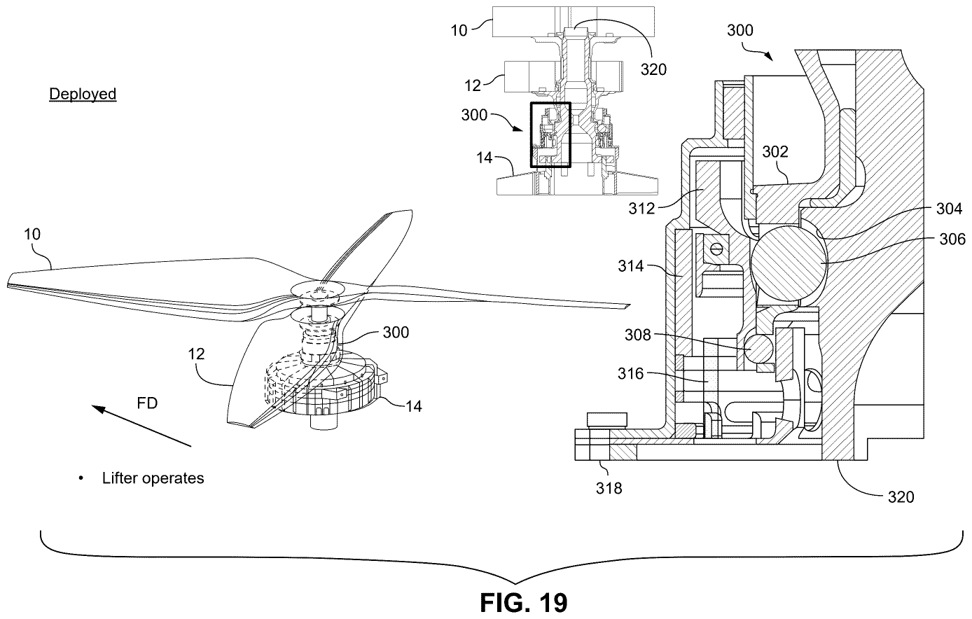

FIGS. 18 and 19 show the lifter motor 14 operating to now turn its shaft 320 clockwise, which causes both propellers 10, 12 to spin together in clockwise rotation (FIG. 28 block 1004). In this mode, the lifter motor rotates clockwise at a desired controlled rate of rotation to rotate the two propellers, generating thrust. In one example, such thrust is upward to lift the aircraft (i.e., by the propeller blades pulling the air downwards and thus the aircraft upwards in the opposite direction), but other orientations of the motor shaft/hub/propellers (and associated thrust direction) are also possible. See for example FIG. 29 which shows an example aircraft with both horizontally-oriented propellers and vertically-oriented propellers. In this “deployed” state, the motor 14 can change rotation rate and can also stop and start as needed to aerodynamically navigate the aircraft in a typical fashion.

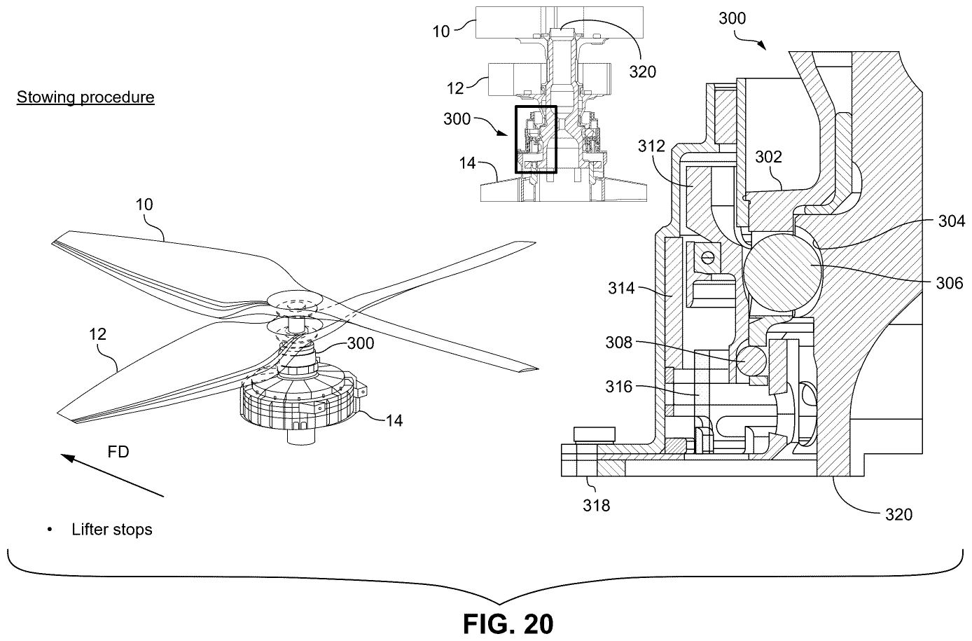

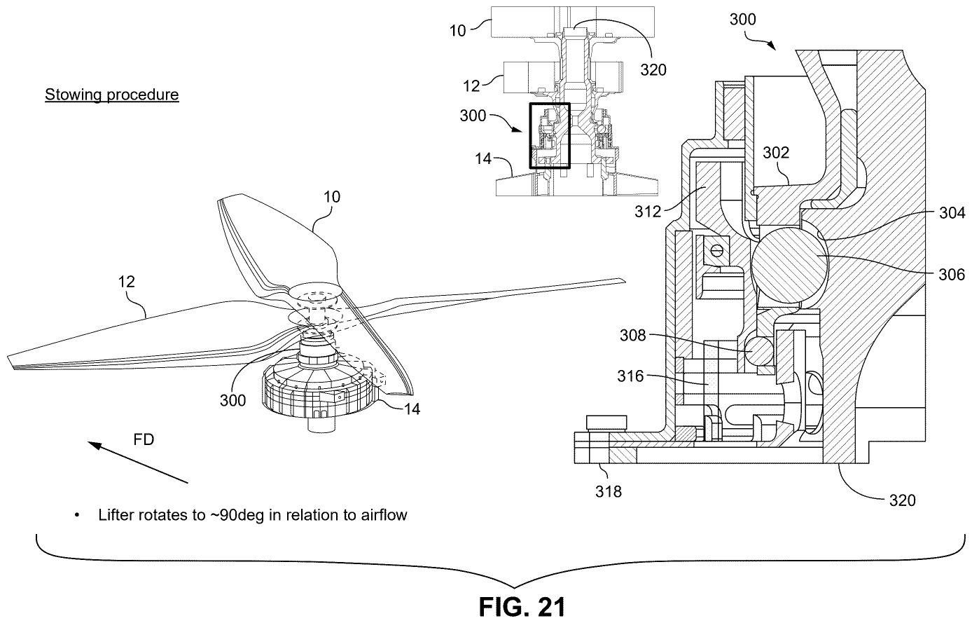

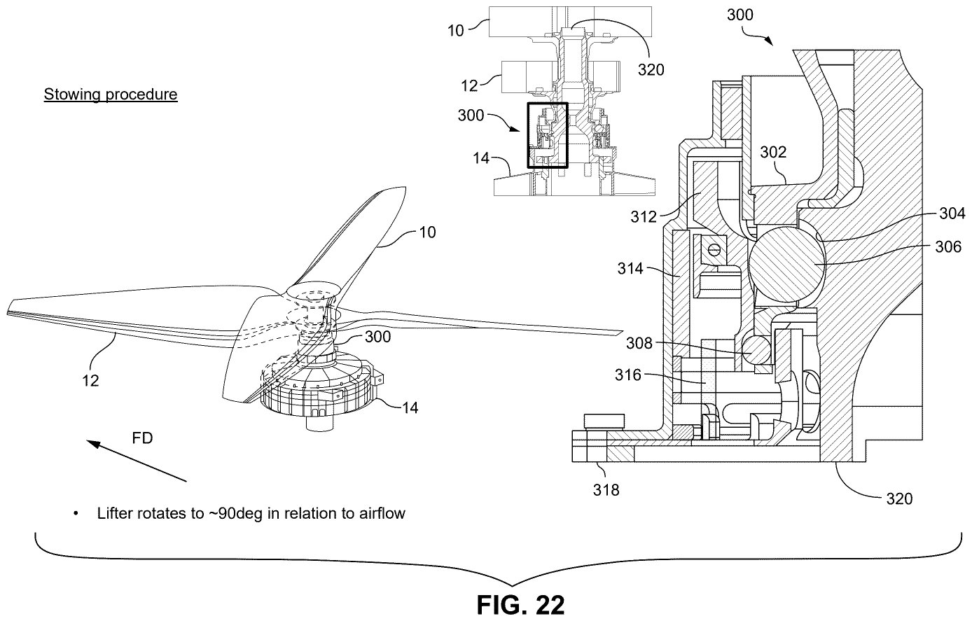

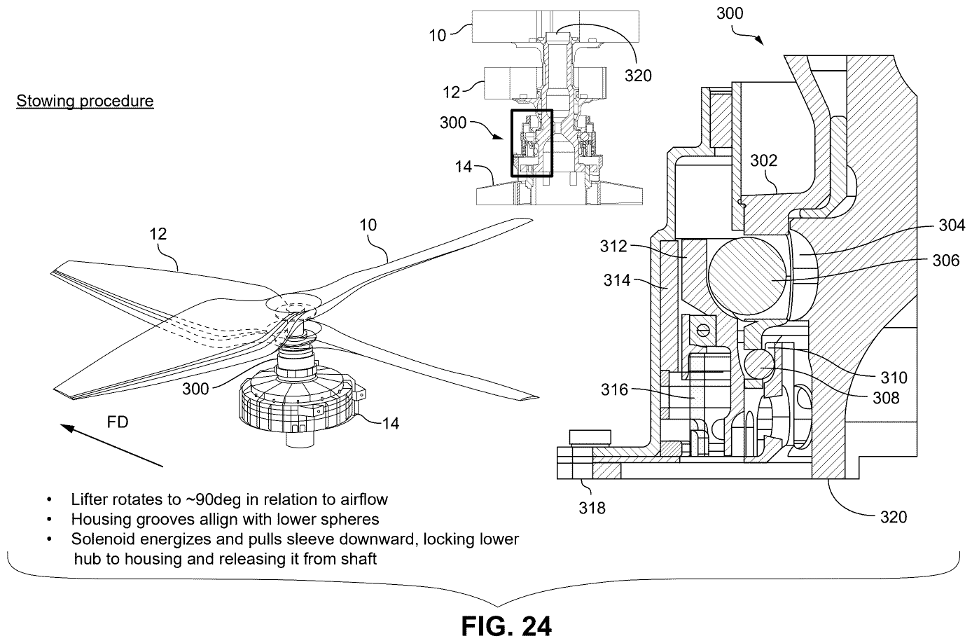

FIGS. 20-27 show a stowing procedure. To stow the propeller assembly, the lifter motor stops rotating (FIG. 20; FIG. 28 block 1006). In one embodiment, the motor is stopped at a particular position of the motor shaft 320 and thus the shaft-engaged lower propeller 12 relative to detected air flow direction, thereby aligning the lower propeller 12 to the air flow. The lifter motor shaft then rotates by a certain amount (e.g., about 90 degrees) CCW in relation to the airflow (FIG. 21, FIG. 22; FIG. 28 block 1008) until the lower housing grooves align with the lower spheres (FIG. 24). In example embodiments, a conventional shaft encoder can be used to detect when the motor shaft 320 has rotated to this position where the lower housing grooves 310 and the lower spheres 308 are aligned. Of course, the shaft grooves 304 at this point continue to be aligned with the upper spheres 306 as they have been for the duration of deployed operation.

Once such alignment is achieved between the lower spheres 308 and the lower housing grooves 310 (as shown in FIG. 24), and assuming the aircraft control system is now going to stow the propellers, the solenoid is energized (FIG. 28 block 1008). If the solenoid were not to be energized for any reason, the lower hub would remain locked to the motor shaft and no change in engagement state will result such that motor torque will continue to rotate both propellers 10, 12.

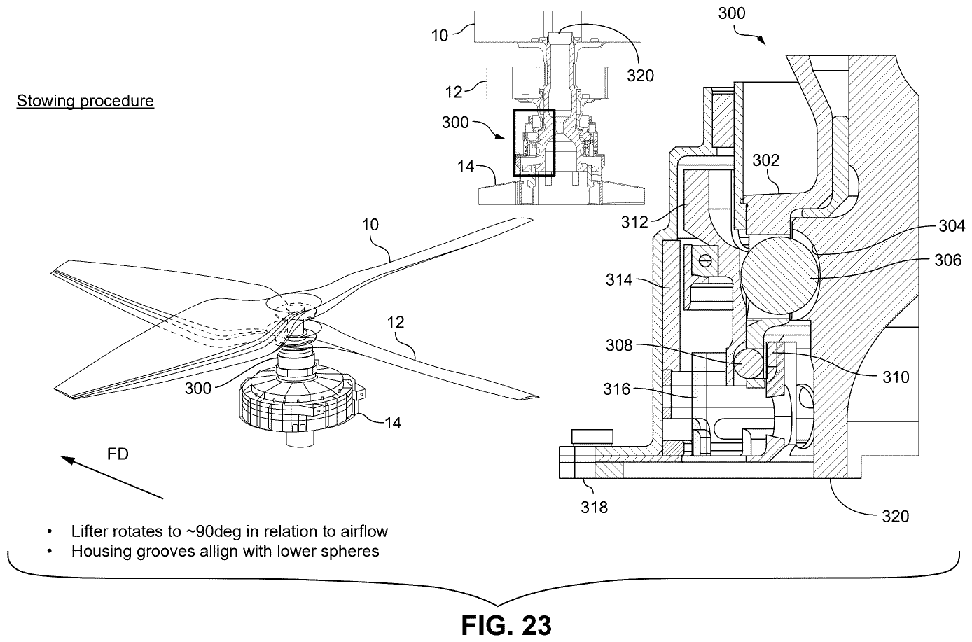

The transition from FIG. 23 to FIG. 24 shows that when the solenoid 314 is energized, the solenoid pulls the sleeve 312 downward. With the sleeve 312 no longer capturing and retaining the upper spheres 306 in their respective shaft grooves 304, the upper spheres move out of their corresponding shaft grooves 304 (compare FIGS. 23, 24). The movement of the upper spheres 306 out of the shaft grooves 304 de-locks (disengages) the lower hub from the motor shaft 320. Meanwhile, the lower spheres 308 now move into their respective now-aligned housing grooves 310 to lock the lower hub to the housing 318. The lower hub is thereby released from the motor shaft 320 and is instead locked to the housing 318. See FIG. 28 block 1008.

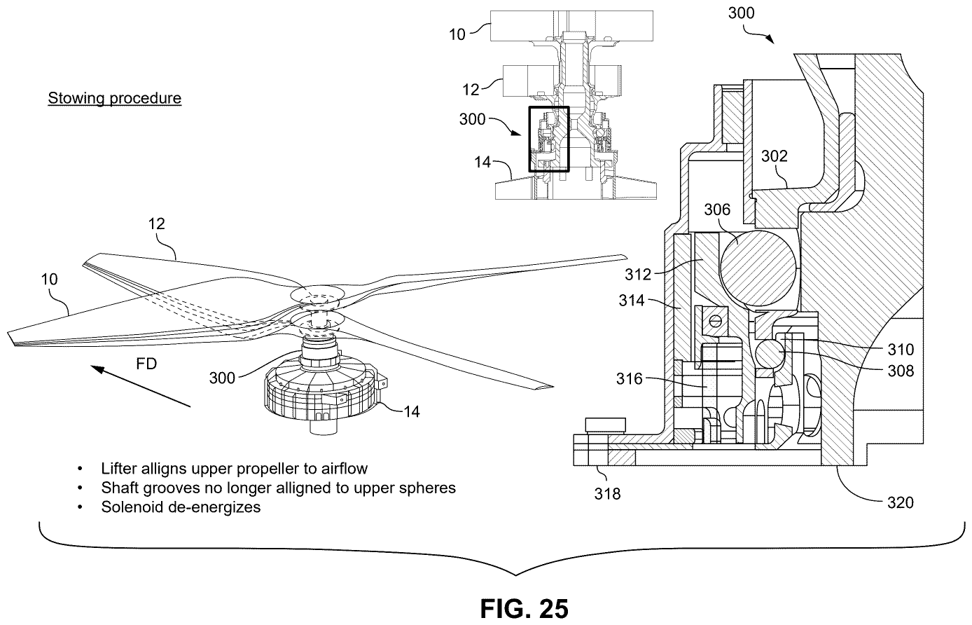

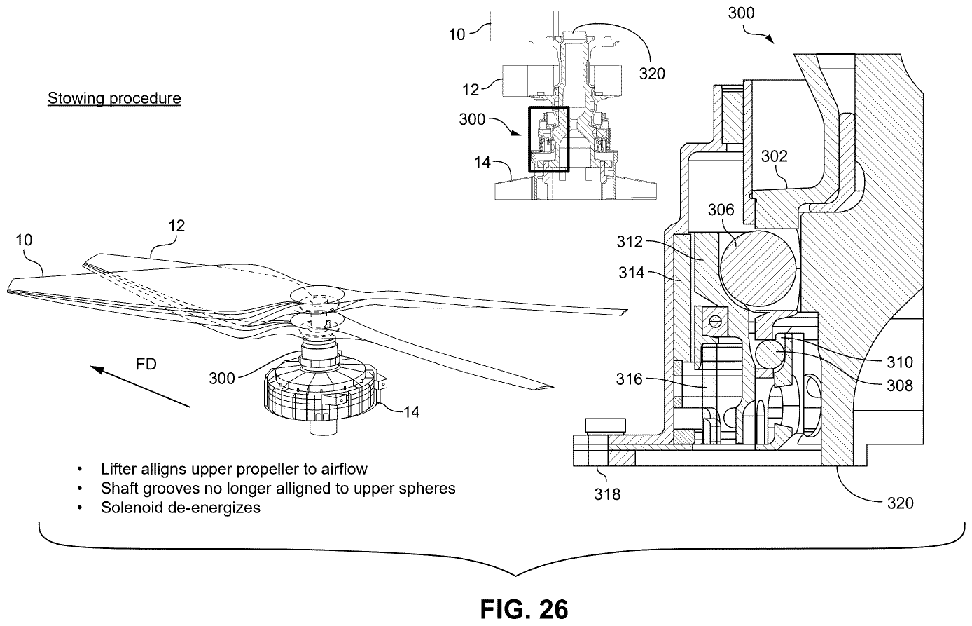

FIG. 25 shows the motor shaft is then rotated clockwise by a certain amount (e.g., 90 degrees in one embodiment) to now also align the upper propeller 10 to airflow (FIG. 28 block 1010) and disalign the shaft grooves 304 from the upper spheres 306. This can be performed by an automatic controller (see FIG. 28A) that uses a suitable sensor to determine the direction of the air flow and a shaft encoder to determine the rotational position of the motor shaft. Such a controller may rotate the motor shaft 320 until the upper propellor 10 is also aligned with the airflow direction in order to present the smallest surface area to the airflow and thus reduce drag. During such rotation, the shaft grooves 304 are de-aligned from the upper spheres 306 and the upper spheres thus block the sleeve 312 from sliding upwardly under the force of the now-compressed spring 316. When a desired position is attained (FIGS. 25, 26), the solenoid is de-energized.

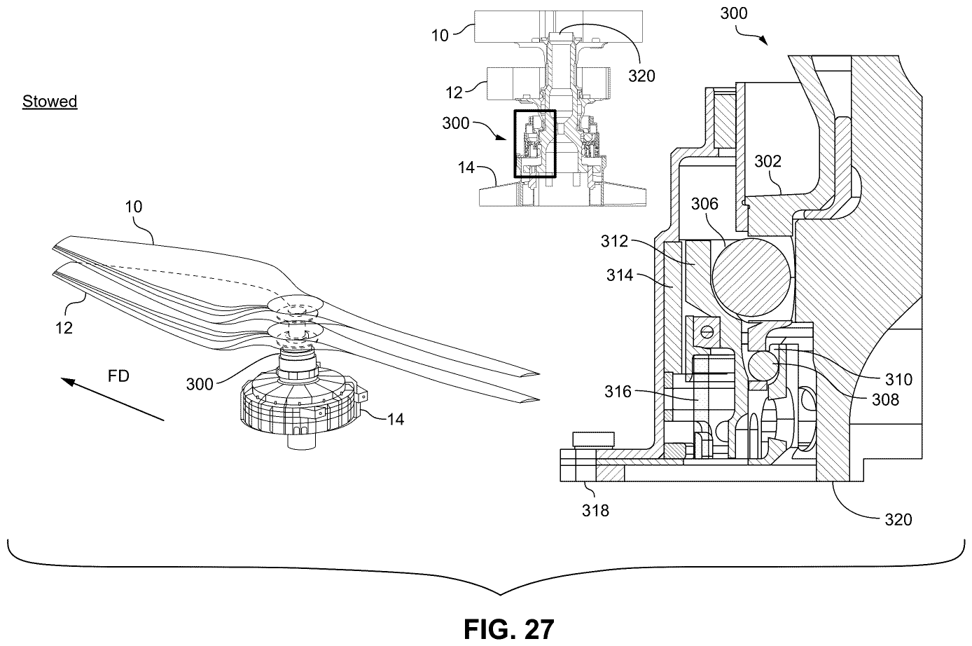

FIG. 27 shows an example final stowed position where the upper propeller 10 and the lower propeller 12 are parallel to each other, with the upper propeller 10 being held in position by motor torque and the lower propeller 12 being locked to the motor housing 14, each propeller in a position that minimizes drag relative to the air flow direction (indicated here as the arrow “FD”).

The term “motor” as used above is not intended to be limiting, but rather may be broadly interpreted to mean and cover any prime mover that can rotate and apply torque to a shaft, including for example an electric motor(s) and/or an internal combustion engine(s). Additionally, the spheres describe above are not limited to perfect spheres but could have other shape or shapes that allow them to engage with and disengage from corresponding grooves as described.

It should also be noted that the angle by which the upper propeller 10 is rotated counterclockwise or clockwise to achieve alignment or disalignment between the upper spheres 306 and their associated shaft grooves 304 and alignment or disalignment between the lower spheres 308 and their associated housing grooves 310 may depend on the position and number of sets of spheres/grooves that are radially spaced around shaft 314. Rotating the shaft 314 from an angular position where a particular upper sphere 306 is aligned with a corresponding shaft groove 304 to a position where that particular upper sphere is aligned with a “next” shaft groove 304 in the shaft 314 will only repeat the same alignment/disalignment condition with a different shaft groove. Rather, achieving alignment involves rotating the shaft 314 to a position where ALL upper spheres 306 are aligned with their corresponding shaft grooves 304, and achieving disalignment involves rotating the shaft 314 to a position where NO upper sphere 306 is aligned with its corresponding shaft groove 304. In the example embodiment described, counterclockwise shaft rotation of about 90 degrees achieves this end where the shaft grooves 304 are regularly angularly spaced fewer (e.g., 60) degrees apart from one another such that a 90 degree reverse (CCW) shaft rotation is guaranteed to align all upper spheres 306 with corresponding shaft grooves 304, and a 90 degree forward (CW) shaft rotation from that position is guaranteed to disalign all upper spheres 306 with corresponding shaft grooves (assuming the slidable sleeve 312 is in the lowermost position which frees the upper spheres from their corresponding shaft grooves). Other embodiments with different shaft groove angular spacings and different numbers of spheres may use different shaft angular displacements to achieve alignment and disalignment as described.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A propeller hub to angularly displace a first propeller relative to a second propeller from a first angular position to a second angular position different from the first angular position, the propeller hub being connectable to a rotatable shaft, the propeller hub comprising at least one spherical connector that is selectively moveable within at least one corresponding groove or channel to selectively lock at least one of the first propeller and the second propeller in a predetermined angular position relative to the other propeller.

2. The propeller hub of claim 1 wherein the spherical connector comprises a sphere.

3. The propeller hub of claim 1 wherein the propeller hub includes a spring that acts on a displaceable plunger or sleeve within the hub.

4. The propeller hub of claim 1 further including an actuator that selectively acts against force a spring applies.

5. The propeller hub of claim 1 further including a centrifugal lock.

6. The propeller hub of claim 1 further comprising a plurality of sets of grooves or channels that are angularly arranged about the shaft.

7. The propeller hub of claim 1 wherein the at least one corresponding groove or channel is defined within the shaft.

8. The propeller hub of claim 1 wherein the first relative angular position comprises a stowed position and the second relative angular position comprises a deployed position.

9. The propeller hub of claim 8 wherein the first and second propellers are parallel to one another in the first relative angular position and are anti-parallel to one another in the second relative angular position.

10. The propeller hub of claim 1 wherein the propeller hub is configured to angularly displace the first propeller relative to the second propeller in a first direction based on drag torque, and to displace the first propeller relative to the second propeller in a second direction relative to the first direction in response to inertial torque and spring bias.

11. The propeller hub of claim 1 further comprising a sleeve configured to move axially to the shaft between a first sleeve position and a second sleeve position, the sleeve being further configured to lock engagement of the first propeller to the shaft in the first sleeve position, the sleeve being further configured to lock engagement of the first propeller to a fixed structure in the second sleeve position.

12. A propeller hub connectable to a rotatable motor shaft, the propeller hub comprising:
a slidable structure that is slidable between a first position and a second position;
a spring that urges the slidable structure toward the first position; and
at least one sphere that is selectively moveable within at least one corresponding groove or channel to selectively lock a propeller in a predetermined angular position relative to the shaft depending on the slidable position of the slidable structure.

13. The propeller hub of claim 12 further including an actuator that urges the slidable structure toward the second position.

14. The propeller hub of claim 12 wherein the propeller hub has no actuator that urges the slidable structure toward the second position.

15. The propeller hub of claim 12 further including a further propeller fixedly connected to the shaft.

16. The propeller hub of claim 12 wherein the slidable structure comprises a plunger.

17. The propeller hub of claim 12 wherein the slidable structure comprises a sleeve.

18. The propeller hub of claim 12 further including a centrifugal locking device.

19. The propeller hub of claim 12 further wherein the at least one sphere includes plural spheres angularly spaced about the shaft that are selectively, synchronously moveable within corresponding grooves or channels also angularly spaced about the shaft, wherein the angular positions of the grooves or channels are changeable relative to the plural spheres.

20. An aircraft comprising:
a wing,
a motor applying torque to a shaft;
a first propeller connected to the shaft; and
a propeller hub connected to the shaft, the propeller hub transmitting torque from the shaft to a second propeller,
wherein the propeller hub is configured to change angular position of the second propeller relative to the shaft,
wherein the propeller hub includes at least one spherical connector that selectively moves into or through a corresponding channel or groove to selectively lock the second propeller in a predetermined changed angular position to generate thrust for the aircraft.
